(19) United States
(12) Patent Application Publication
(10) Pub. No.: US 2025/0350518 A1
(43) Pub. Date: Nov. 13, 2025

(54) DYNAMIC ADAPTATION OF SOUNDING REFERENCE SIGNAL FREQUENCY DOMAIN PARAMETERS

(71) Applicant: QUALCOMM Incorporated, San Diego, CA (US)

(72) Inventors: Michael LEVITSKY, Rehovot (IL); Muhammad Sayed Khairy ABDELGHAFFAR, San Jose, CA (US); Daniel PAZ, Atlit (IL)

(21) Appl. No.: 18/860,912

(22) PCT Filed: Jun. 14, 2023
(86) PCT No.: PCT/US2023/025311

§ 371 Date: Oct. 28, 2024

(30) Foreign Application Priority Data
Jun. 22, 2022 (IL) 294194

(51) Int. Cl. H04L 27/26; H04L 5/00; H04W 72/0453

(52) U.S. Cl. CPC H04L 27/261; H04L 5/0044; H04L 5/0055; H04W 72/0453

(57) ABSTRACT

Various aspects of the present disclosure generally relate to wireless communication. In some aspects, a first network node may receive, from a second network node, a sounding reference signal (SRS) configuration associated with an SRS resource set including one or more SRS resources, the SRS configuration indicating information for a set of one or more frequency domain parameters associated with the SRS resource set. The first network node may receive, from the second network node, a message indicating modified information for a dynamic reconfiguration of one or more frequency domain parameters, from the set of one or more frequency domain parameters, associated with at least one SRS resource. The first network node may transmit, to the second network node, an SRS, using the at least one SRS resource, in accordance with the modified information for the one or more frequency domain parameters. Numerous other aspects are described.

### CROSS-REFERENCE TO RELATED APPLICATION

This Patent Application claims priority to Israel Patent Application No. 294194, filed on Jun. 22, 2022, entitled “DYNAMIC ADAPTATION OF SOUNDING REFERENCE SIGNAL FREQUENCY DOMAIN PARAMETERS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for dynamic adaptation of sounding reference signal (SRS) frequency domain parameters.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a first network node for wireless communication. The first network node may include a memory and one or more processors coupled to the memory. The one or more processors may be configured to receive, from a second network node, a sounding reference signal (SRS) configuration associated with an SRS resource set including one or more SRS resources, the SRS configuration indicating information for a set of one or more frequency domain parameters associated with the SRS resource set. The one or more processors may be configured to receive, from the second network node, a message indicating modified information for a dynamic reconfiguration of one or more frequency domain parameters, from the set of one or more frequency domain parameters, associated with at least one SRS resource of the one or more SRS resources. The one or more processors may be configured to transmit, to the second network node, an SRS, using the at least one SRS resource, in accordance with the modified information for the one or more frequency domain parameters.

Some aspects described herein relate to a first network node for wireless communication. The first network node may include a memory and one or more processors coupled to the memory. The one or more processors may be configured to transmit, to a second network node, an SRS configuration associated with an SRS resource set including one or more SRS resources, the SRS configuration indicating information for a set of one or more frequency domain parameters associated with the SRS resource set. The one or more processors may be configured to transmit, to the second network node, a message indicating modified information for a dynamic reconfiguration of one or more frequency domain parameters, from the set of one or more frequency domain parameters, associated with at least one SRS resource of the one or more SRS resources. The one or more processors may be configured to receive, from the second network node, an SRS, using the at least one SRS resource, in accordance with the modified information for the one or more frequency domain parameters.

Some aspects described herein relate to a method of wireless communication performed by a first network node. The method may include receiving, from a second network node, an SRS configuration associated with an SRS resource set including one or more SRS resources, the SRS configuration indicating information for a set of one or more frequency domain parameters associated with the SRS resource set. The method may include receiving, from the second network node, a message indicating modified information for a dynamic reconfiguration of one or more frequency domain parameters, from the set of one or more frequency domain parameters, associated with at least one SRS resource of the one or more SRS resources. The method may include transmitting, to the second network node, an SRS, using the at least one SRS resource, in accordance with the modified information for the one or more frequency domain parameters.

Some aspects described herein relate to a method of wireless communication performed by a first network node. The method may include transmitting, to a second network node, an SRS configuration associated with an SRS resource set including one or more SRS resources, the SRS configuration indicating information for a set of one or more frequency domain parameters associated with the SRS resource set. The method may include transmitting, to the second network node, a message indicating modified information for a dynamic reconfiguration of one or more frequency domain parameters, from the set of one or more frequency domain parameters, associated with at least one SRS resource of the one or more SRS resources. The method may include receiving, from the second network node, an SRS, using the at least one SRS resource, in accordance with the modified information for the one or more frequency domain parameters.

Some aspects described herein relate to a non-transitory computer-readable medium having instructions for wireless communication stored thereon that when executed by a first network node, cause the first network node to receive, from a second network node, an SRS configuration associated with an SRS resource set including one or more SRS resources, the SRS configuration indicating information for a set of one or more frequency domain parameters associated with the SRS resource set. The instructions, when executed by the first network node, may cause the first network node to receive, from the second network node, a message indicating modified information for a dynamic reconfiguration of one or more frequency domain parameters, from the set of one or more frequency domain parameters, associated with at least one SRS resource of the one or more SRS resources. The instructions, when executed by the first network node, may cause the first network node to transmit, to the second network node, an SRS, using the at least one SRS resource, in accordance with the modified information for the one or more frequency domain parameters.

Some aspects described herein relate to a non-transitory computer-readable medium having instructions for wireless communication stored thereon that when executed by a first network node, cause the first network node to transmit, to a second network node, an SRS configuration associated with an SRS resource set including one or more SRS resources, the SRS configuration indicating information for a set of one or more frequency domain parameters associated with the SRS resource set. The instructions, when executed by the first network node, may cause the first network node to transmit, to the second network node, a message indicating modified information for a dynamic reconfiguration of one or more frequency domain parameters, from the set of one or more frequency domain parameters, associated with at least one SRS resource of the one or more SRS resources. The instructions, when executed by the first network node, may cause the first network node to receive, from the second network node, an SRS, using the at least one SRS resource, in accordance with the modified information for the one or more frequency domain parameters.

Some aspects described herein relate to an apparatus for wireless communication. The apparatus may include means for receiving, from a network node, an SRS configuration associated with an SRS resource set including one or more SRS resources, the SRS configuration indicating information for a set of one or more frequency domain parameters associated with the SRS resource set. The apparatus may include means for receiving, from the network node, a message indicating modified information for a dynamic reconfiguration of one or more frequency domain parameters, from the set of one or more frequency domain parameters, associated with at least one SRS resource of the one or more SRS resources. The apparatus may include means for transmitting, to the network node, an SRS, using the at least one SRS resource, in accordance with the modified information for the one or more frequency domain parameters.

Some aspects described herein relate to an apparatus for wireless communication. The apparatus may include means for transmitting, to a network node, an SRS configuration associated with an SRS resource set including one or more SRS resources, the SRS configuration indicating information for a set of one or more frequency domain parameters associated with the SRS resource set. The apparatus may include means for transmitting, to the network node, a message indicating modified information for a dynamic reconfiguration of one or more frequency domain parameters, from the set of one or more frequency domain parameters, associated with at least one SRS resource of the one or more SRS resources. The apparatus may include means for receiving, from the network node, an SRS, using the at least one SRS resource, in accordance with the modified information for the one or more frequency domain parameters.

### BRIEF DESCRIPTION OF THE DRAWINGS

The drawings illustrate certain example aspects of this disclosure and are therefore not limiting in scope. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is an example of a disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of sounding reference signal (SRS) resource sets, in accordance with the present disclosure.

FIG. 6 is a diagram of an example associated with dynamic adaptation of SRS frequency domain parameters, in accordance with the present disclosure.

FIG. 7 is a diagram of an example associated with a communication timeline for dynamic adaptation of SRS frequency domain parameters, in accordance with the present disclosure.

FIG. 8 is a diagram of an example associated with a communication timeline for dynamic adaptation of SRS frequency domain parameters, in accordance with the present disclosure.

FIG. 9 is a diagram of an example associated with a SRS trigger state configuration and activation for dynamic adaptation of SRS frequency domain parameters, in accordance with the present disclosure.

FIG. 10 is a diagram illustrating an example process performed, for example, by a first network node, in accordance with the present disclosure.

FIG. 11 is a diagram illustrating an example process performed, for example, by a first network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure, function, example, aspect or the like presented throughout this disclosure. This disclosure includes, for example, any structure, function, example, aspect, or the like disclosed herein, whether implemented independently of or combined with any other aspect of the disclosure. For example, an apparatus may be implemented or a method may be practiced using any number of the aspects set forth herein.

In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems are presented with reference to various apparatuses and techniques. These apparatuses and techniques are described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

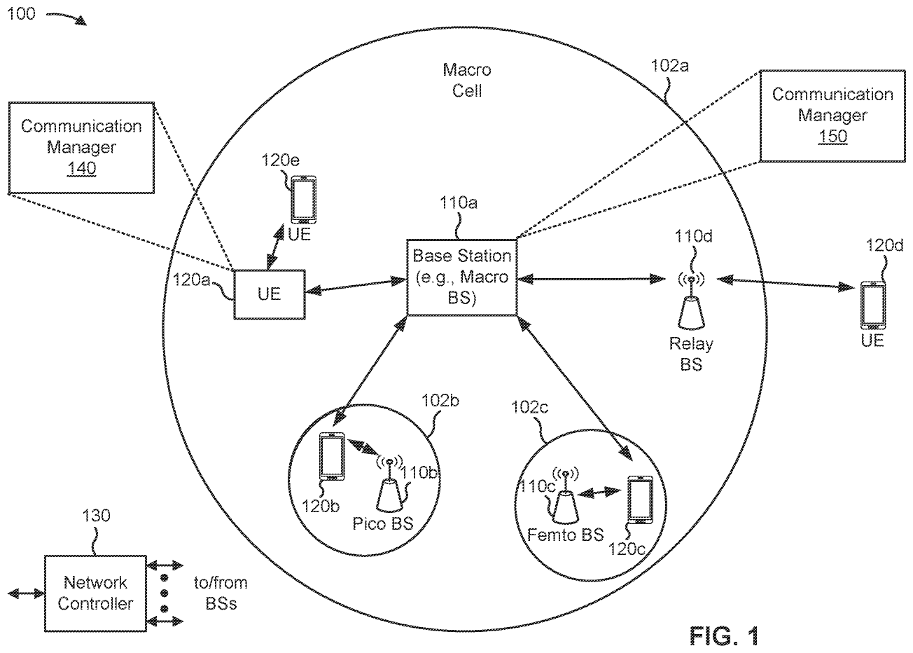

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station. Additionally, or alternatively, a wireless network may include one or more UEs that communicate with each other. For example, a first UE may communicate with a second UE via sidelink communications. “Sidelink” (or “SL”) refers to a communication link between UEs.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 (which may also be referred to as “network nodes” in the wireless network 100 through various types of backhaul interfaces, such as a direct physical connection or a virtual network, using any transport network.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0. 1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other device, system apparatus, node, or the like that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first network node (e.g., shown as the UE 120 in FIG. 1 as an example) may include a communication manager 140. As described in more detail elsewhere herein, the communication manager 140 may receive, from a second network node, a sounding reference signal (SRS) configuration associated with an SRS resource set including one or more SRS resources, the SRS configuration indicating information for a set of one or more frequency domain parameters associated with the SRS resource set; receive, from the second network node, a message indicating modified information for a dynamic reconfiguration of one or more frequency domain parameters, from the set of one or more frequency domain parameters, associated with at least one SRS resources of the one or more SRS resources; and transmit, to the second network node, an SRS, using the at least one SRS resource, in accordance with the modified information for the one or more frequency domain parameters. Additionally, or alternatively, the communication manager 140 may perform one or more other operations described herein.

In some aspects, a first network node (e.g., shown as the base station 110 in FIG. 1 as an example) may include a communication manager 150. As described in more detail elsewhere herein, the communication manager 150 may transmit, to a second network node, an SRS configuration associated with an SRS resource set including one or more SRS resources, the SRS configuration indicating information for a set of one or more frequency domain parameters associated with the SRS resource set; transmit, to the second network node, a message indicating modified information for a dynamic reconfiguration of one or more frequency domain parameters, from the set of one or more frequency domain parameters, associated with at least one SRS resources of the one or more SRS resources; and receive, from the second network node, an SRS, using the at least one SRS resource, in accordance with the modified information for the one or more frequency domain parameters. Additionally, or alternatively, the communication manager 150 may perform one or more other operations described herein.

As indicated above, FIG. 1 is provided as an example. Other examples may differ from what is described with regard to FIG. 1.

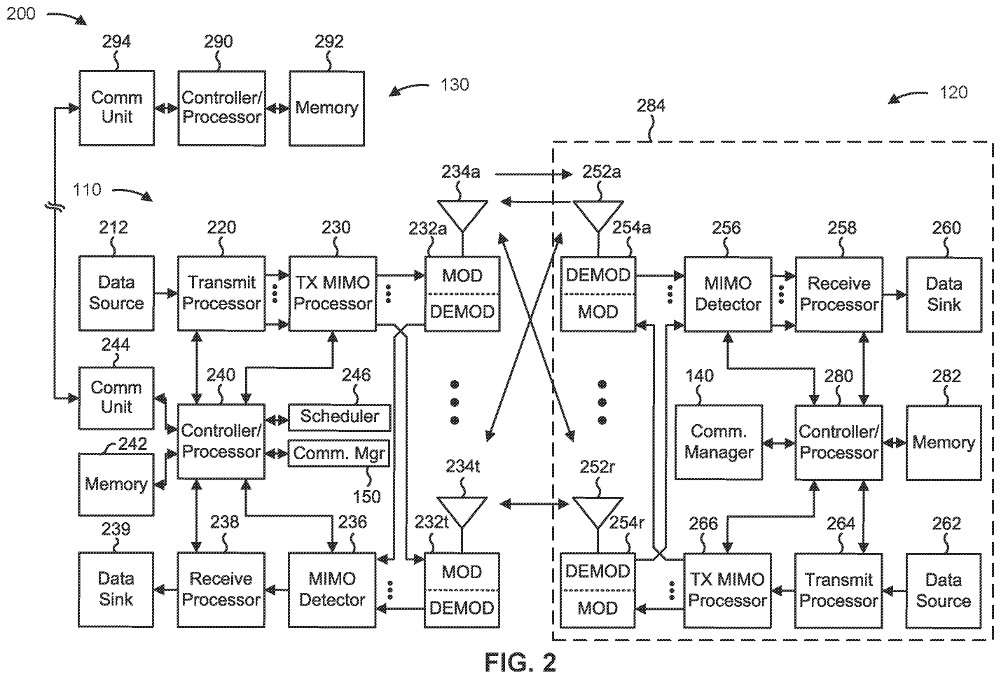

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based on one or more channel quality indicators (CQIs) received from that UE 120. The base station 110 may process (e.g., encode and modulate) the data for the UE 120 based on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

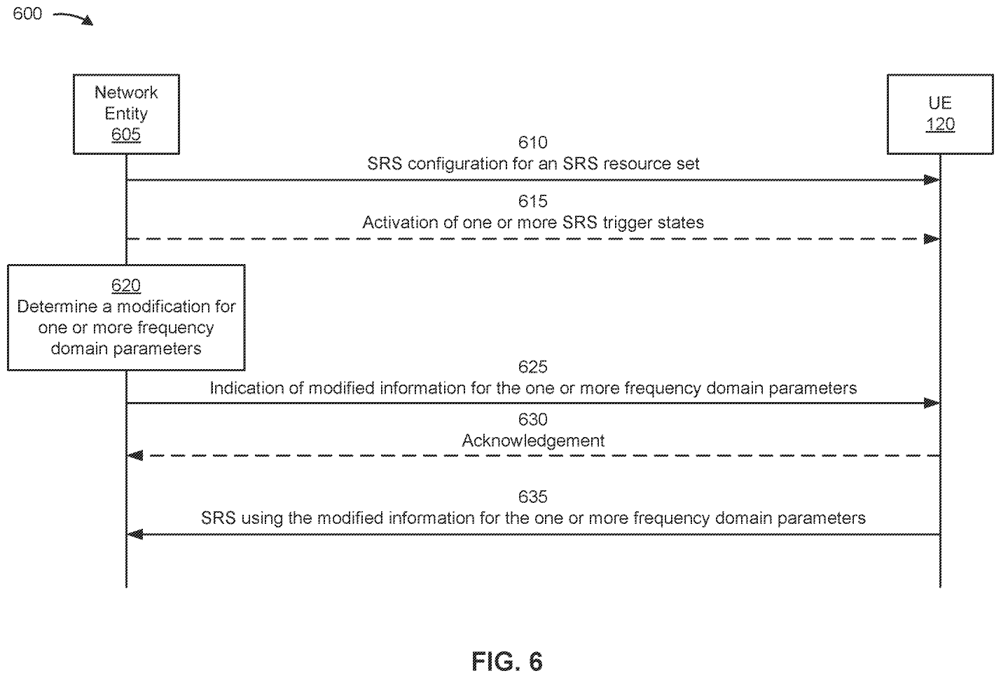

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-13).

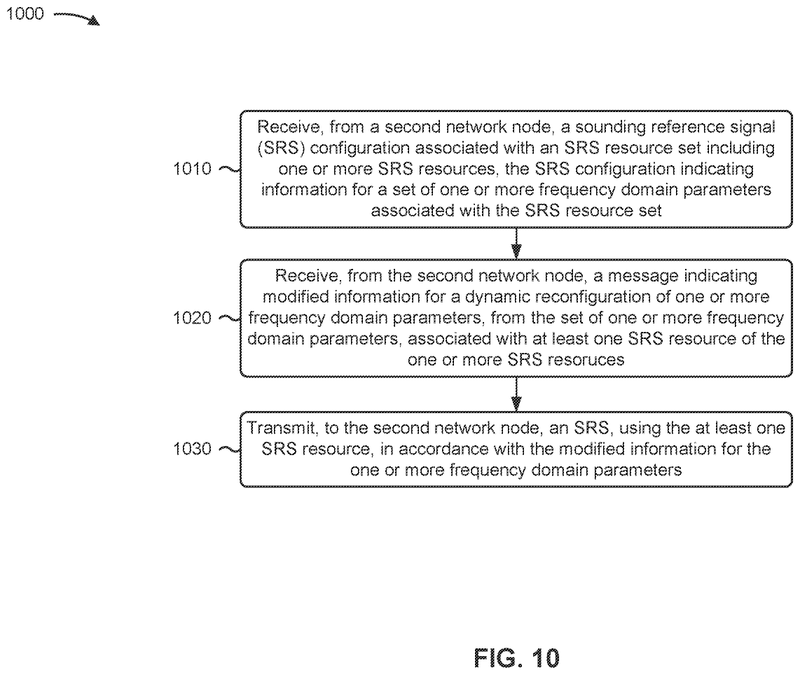

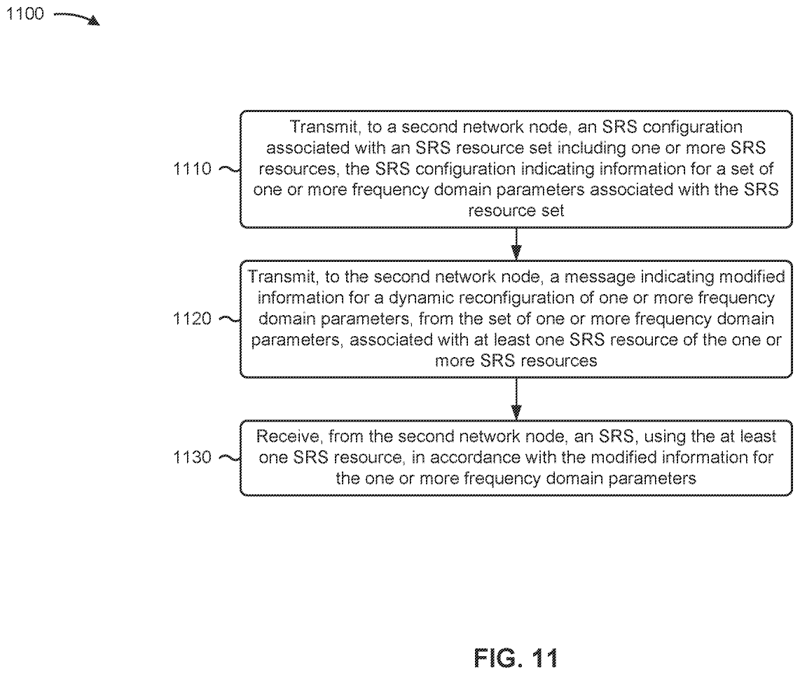

The controller/processor 240 of the base station 110, the controller/processor 280 of the UE 120, and/or any other component(s) of FIG. 2 may perform one or more techniques associated with dynamic adaptation of SRS frequency domain parameters, as described in more detail elsewhere herein. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a first network node (e.g., a UE 120 or another network node) includes means for receiving, from a second network node, an SRS configuration associated with an SRS resource set including one or more SRS resources, the SRS configuration indicating information for a set of one or more frequency domain parameters associated with the SRS resource set; means for receiving, from the second network node, a message indicating modified information for a dynamic reconfiguration of one or more frequency domain parameters, from the set of one or more frequency domain parameters, associated with at least one SRS resources of the one or more SRS resources; and/or means for transmitting, to the second network node, an SRS, using the at least one SRS resource, in accordance with the modified information for the one or more frequency domain parameters. In some aspects, the means for the first network node to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a first network node (e.g., a base station 110, a network entity, or another network node) includes means for transmitting, to a second network node, an SRS configuration associated with an SRS resource set including one or more SRS resources, the SRS configuration indicating information for a set of one or more frequency domain parameters associated with the SRS resource set; means for transmitting, to the second network node, a message indicating modified information for a dynamic reconfiguration of one or more frequency domain parameters, from the set of one or more frequency domain parameters, associated with at least one SRS resources of the one or more SRS resources; and/or means for receiving, from the second network node, an SRS, using the at least one SRS resource, in accordance with the modified information for the one or more frequency domain parameters. In some aspects, the means for the first network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

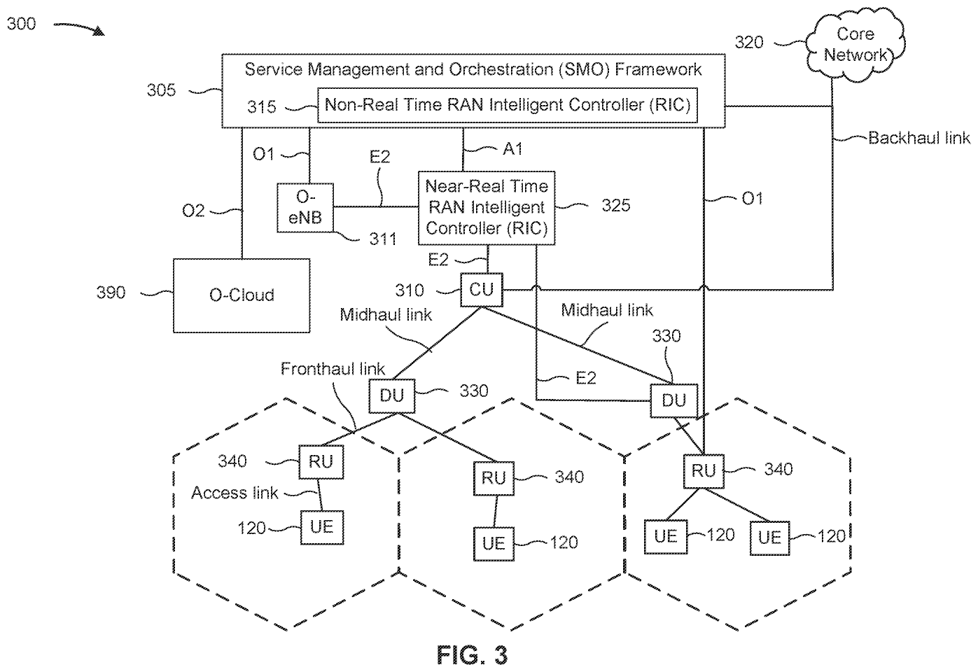

FIG. 3 is an example of a disaggregated base station architecture 300, in accordance with the present disclosure. The disaggregated base station architecture 300 shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

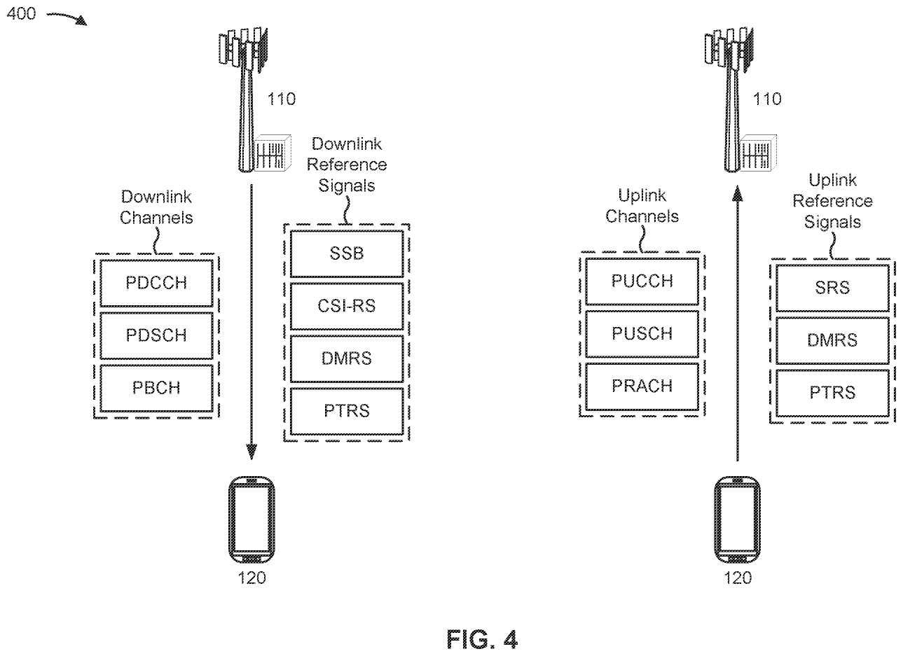

FIG. 4 is a diagram illustrating an example 400 of physical channels and reference signals in a wireless network, in accordance with the present disclosure. As shown in FIG. 4, downlink channels and downlink reference signals may carry information from a network entity (e.g., described and depicted in connection with FIG. 4 as a base station 110 as an example) to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least on the measurements, the UE 120 may perform channel estimation and may report channel estimation parameters to the base station 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The base station 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least on the measurements, and may use the SRS measurements to configure communications with the UE 120.

Reference signals may be used to increase the reliability and efficiency of communications between wireless devices. For example, a base station 110 may measure an uplink reference signal to select a configuration or other transmission parameters for communications between the base station 110 and a UE 120. For example, the base station 110 may measure an uplink reference signal to estimate a delay spread, signal-to-noise ratio (SNR), and/or a Doppler parameter (e.g., Doppler shift or Doppler spread) associated with the uplink channel, among other examples.

“Doppler shift” refers to a shift or change in a frequency of a signal between a transmitter and a receiver. Doppler shift may sometimes be referred to as a frequency offset. For example, Doppler shift may occur when a transmitter of a signal is moving in relation to the receiver. The relative movement may shift the frequency of the signal, making the frequency of the signal received at the receiver different than the frequency of the signal transmitted at the transmitter. In other words, the frequency of the signal received by the receiver differs from the frequency of the signal that was originally emitted. “Doppler spread” refers to the widening of a spectrum of a narrow-band signal transmitted through a multipath propagation channel. Doppler spread may be caused by different Doppler shifts associated with the multiple propagation paths when there is relative motion between the transmitter and the receiver. For example, when there is no relative motion between the transmitter and the receiver, due to the multipath propagation channel, the receiver can receive the same signal at different times, because one copy of the signal uses a shorter path and arrives quickly, whereas another copy of the signal may user a longer path. Where there is relative motion between the transmitter and the receiver, signals on the different paths may arrive at the receiver at different times and with different frequencies (e.g., due to different Doppler shifts associated with each path). Doppler spread may be a measure of a difference in frequencies of signals on the paths associated with the multipath propagation channel. Doppler spread may sometimes be referred to as a channel time correlation or a channel time coherency characteristic for a multipath propagation channel.

As indicated above, FIG. 4 is provided as an example. Other examples may differ from what is described with regard to FIG. 4.

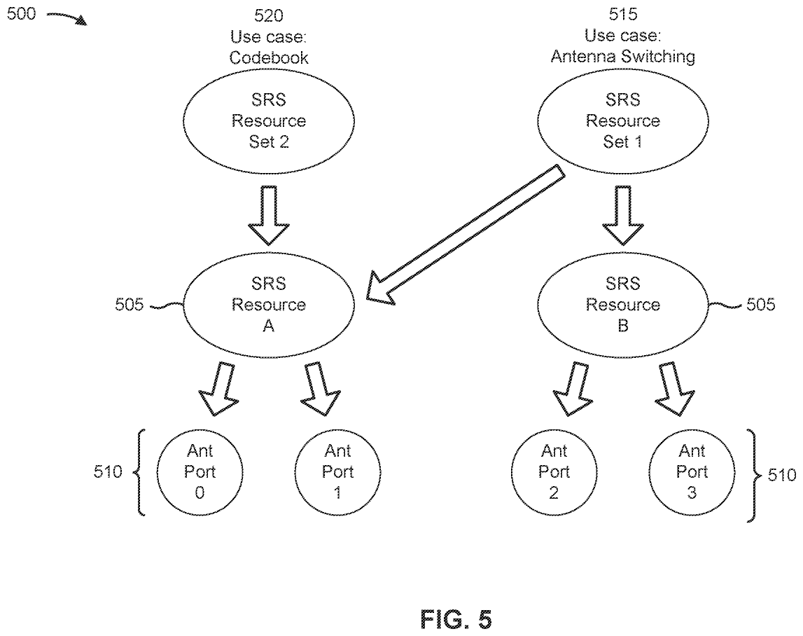

FIG. 5 is a diagram illustrating an example 500 of SRS resource sets, in accordance with the present disclosure. A network entity (e.g., depicted and described in connection with FIG. 5 as a base station 110 as an example) may configure a UE 120 with one or more SRS resource sets to allocate resources for SRS transmissions by the UE 120. For example, a configuration for SRS resource sets may be indicated in a radio resource control (RRC) message (e.g., an RRC configuration message or an RRC reconfiguration message). As shown by reference number 505, an SRS resource set may include one or more resources (e.g., shown as SRS resources), which may be associated, or configured, with a different time resources and/or frequency resources (e.g., a slot, a symbol. a resource block, a resource elements subset, and/or a periodicity for the time resources).

As shown by reference number 510, an SRS resource may be configured to be associated with one or more antenna ports on which an SRS is to be transmitted (e.g., on a corresponding time-frequency resources). Thus, a configuration for one or more SRS resources which are associated or configured with an SRS resource set may indicate one or more time-frequency resources on which an SRS is to be transmitted and may indicate one or more antenna ports using which the SRS is to be transmitted on those time-frequency resources. In some aspects, the configuration for an SRS resource set may indicate a use case (e.g., in an SRSResourceSet.Usage information element) for the SRS resource set. For example, an SRS resource set may have a use case of antenna switching, codebook, non-codebook, or beam management.

An antenna switching SRS resource set may be used to determine downlink CSI with reciprocity between an uplink and downlink channel. For example, when there is reciprocity between an uplink channel and a downlink channel, a base station 110 may use an antenna switching SRS (e.g., an SRS transmitted using SRS resources configured under one or more antenna switching SRS resource sets) to acquire downlink CSI (e.g., to determine a downlink precoder to be used to communicate with the UE 120).

A codebook SRS resource set may be used for a determination of uplink CSI when a base station 110 evaluates and indicates an uplink precoder to the UE 120 based on the uplink CSI. For example, when the base station 110 is configured to determine an uplink precoder to the UE 120 (e.g., using a precoder codebook), the base station 110 may use a codebook SRS (e.g., an SRS transmitted using resources of a codebook SRS resource set) to acquire uplink CSI (e.g., to determine an uplink precoder to be indicated to the UE 120 and used by the UE 120 to communicate with the base station 110). In some aspects, virtual ports (e.g., a combination of two or more antenna ports) that may be associated with a maximum received signal power or reception quality experienced by the base station 110 may be used for a codebook SRS.

A non-codebook SRS resource set may be used in case of a reciprocal uplink and downlink channel to assist in uplink CSI evaluation when the UE 120 pre-selects one or more uplink precoder candidate options (e.g., instead of the base station 110 automatously evaluating uplink precoder candidates and selecting one to be indicated explicitly to the UE 120 for uplink precoding). For example, when the UE 120 is configured to transmit a non-codebook based SRS, the UE 120 may select one or more uplink precoder candidates based on downlink measurements and will use the one or more uplink precoder candidates for different SRS resources transmission (e.g. pre-coded SRS will be transmitted where each SRS resource will be associated with a different uplink precoder candidate). The base station 110 may use a non-codebook SRS (e.g., an SRS transmitted using resources of a non-codebook SRS resource set) to select one of the precoder candidates and to acquire other uplink CSI parameters given the selected uplink precoder candidate. In this case, uplink transmission parameters may be indicated by the base station 110 to the UE 120 at least partially implicitly (e.g., precoding information) based on the selected non codebook SRS resource (e.g. via an SRI indicator). A beam management SRS resource set may be used for uplink beam selection and/or evaluation by a base station 110 (e.g. for millimeter wave communications).

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. A penodic SRS resource set may always activated (e.g., transmitted), and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a medium access control (MAC) control element (CE) (MAC-CE)). An aperiodic SRS resource may be triggered dynamically, such as via DCI (e.g., UE-specific DCI or group common DCI).

In some examples, an aperiodic SRS resource may be triggered via an SRS request field included in a DCI message. For example, the SRS request field may include a value (e.g., a codepoint) that is associated with an SRS trigger state. “SRS trigger state” may refer to a configuration (e.g., an RRC configuration) of a list of one or more SRS resource sets to be triggered by DCI when the DCI indicates the specific SRS trigger state (e.g., via an SRS request field in the DCI). SRS trigger states may be RRC configured by a network entity (e.g., via one or more aperiodicSRS-ResourceTrigger parameters). Different SRS trigger states can be indicated or selected dynamically by the base station 110 via DCI. For example, configuration information (e.g., RRC configuration information) may map or link each SRS trigger state to a codepoint for a DCI field (e.g., the SRS request field) or to another indicator. The base station 110 may include the codepoint or indicator in DCI (e.g., in an SRS request field) to dynamically trigger or select the SRS trigger state linked to or associated with an SRS resource set (or several SRS resource sets). In some examples, the configuration information may configure a linkage or association of different SRS trigger states to different SRS resource sets having different usage types, such as antenna switching, codebook, non-codebook, beam management, and/or positioning, among other examples.

In some aspects, the UE 120 may be configured with a mapping between SRS ports (e.g., antenna ports) and corresponding SRS resources (e.g. which antenna port(s) to be used for every SRS resource). The UE 120 may transmit a particular SRS resource using an SRS port indicated in the configuration. In some aspects, an SRS resource may span N adjacent symbols within a slot (e.g., where N equals 1, 2, or 4). The UE 120 may be configured with X SRS ports (e.g., where X=1, 2, 4). In some aspects, each of the X SRS ports may mapped to a corresponding symbol of the SRS resource and used for transmission of the SRS on that symbol.

As shown in FIG. 5, in some aspects, different SRS resource sets indicated to the UE 120 (e.g. having different use cases) may overlap in terms of the associated SRS resources (e.g., may be configured with one or more same SRS resource identifiers). For example, as shown by reference number 515, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS will be transmitted according to or using SRS Resource A configuration (e.g., a first time-frequency resource) using antenna port 0 and antenna port 1 and according to or using SRS Resource B configuration (e.g., a second time-frequency resource) using antenna port 2 and antenna port 3.

As shown by reference number 520, a second SRS resource set (e.g., shown as SRS Resource Set 2) may be configured for codebook use case or type. As shown, this example codebook SRS resource set includes only the first SRS resource (shown as SRS Resource A). Thus, codebook SRS may be transmitted using SRS Resource A configuration (e.g., the first time-frequency resource) via antenna port 0 and antenna port 1.

As described above, a network entity (e.g., the base station 110) may configure one or more SRS resource sets. For example, the network entity may configure an SRS resource set including one or more frequency domain parameters (e.g., indicating information or a configuration associated with a location and/or pattern of the SRS resources linked with the SRS resource set in the frequency domain), one or more time domain parameters (e.g., indicating information associated with a location and/or pattern of SRS resources linked with the SRS resource set in the time domain), and/or one or more spatial domain parameters, among other examples. For example, the frequency domain parameters may include a transmission combination parameter (e.g., a transmissionComb parameter) associated with a frequency domain density, a transmission combination offset parameter (e.g. a combOffset parameter), a frequency domain shift parameter (e.g., a freqDomainShift parameter), a frequency domain position parameter (e.g., a freqDomainPosition parameter), a first frequency domain hopping parameter (e.g., a freqHopping.c-SRS parameter) associated with an SRS bandwidth configuration row index value, a second frequency domain hopping parameter (e.g., a freqHopping.b-SRS parameter) associated with an SRS bandwidth configuration column index value, a third frequency domain hopping parameter (e.g., a freqHopping.b-hop parameter) associated with at least one of indicating whether frequency hopping is enabled, a quantity of frequency hops, or an offset associated with frequency hopping, and/or one or more partial frequency sounding parameters, among other examples.

The transmission combination parameter (e.g., the transmissionComb parameter) may indicate a frequency domain density associated with the SRS resource and/or SRS resource set (e.g., for each SRS port). In some examples, the transmission combination parameter may indicate a pattern of frequency domain resources associated with the SRS resource set. For example, an SRS may not be transmitted in each subcarrier of a bandwidth associated with an SRS resource and/or SRS resource set. A value of the transmission combination parameter may indicate a spacing or distribution of occupied subcarriers or resource elements over the bandwidth associated with an SRS resource. The transmission combination parameter may have a value of 2 (e.g., indicating that one in every 2 subcarriers or resource elements includes an SRS), 4 (e.g., indicating that one in every 4 subcarriers or resource elements includes an SRS), or 8 (e.g., indicating that one in every 8 subcarriers or resource elements includes an SRS), among other examples. The transmission combination offset parameter (e.g., the combOffset parameter) may indicate an offset value from a first resource element included in the bandwidth associated with the SRS resource in which a first SRS resource element (RE) is to be included. Therefore, the transmission combination parameter in combination with the transmission combination offset parameter may indicate specific resource element indices to be associated with SRS resource.

The frequency domain shift parameter (e.g., the freqDomainShift parameter) may indicate a frequency domain offset of the SRS resource REs relative to a corresponding bandwidth part starting position in the frequency domain. The frequency domain position parameter (e.g., the freqDomainPosition parameter) may indicate additional offset in frequency domain resource blocks per SRS transmission relative to the offset defined by the frequency domain shift parameter.

In some examples, frequency hopping may be enabled for SRS transmissions. “Frequency hopping” may refer to the UE using different subsets of frequency domain resources, within a bandwidth part associated with the SRS resource set, for different SRS transmissions. For example, for a first SRS transmission, the UE may use a first set of frequency domain resources. For a second SRS transmission, the UE may use a second set of frequency domain resources. The first set of frequency domain resources and the second set of frequency domain resources may be included in a bandwidth part associated with the SRS resource set. The first frequency domain hopping parameter (e.g., the freqHopping.c-SRS parameter) may indicate a configuration row index value associated with an SRS bandwidth configuration table (e.g., a table defined, or otherwise fixed, by the 3GPP). The second frequency domain hopping parameter (e.g., the freqHopping.b-SRS parameter) may indicate a configuration column index value associated with the SRS bandwidth configuration table. The entry of the SRS bandwidth configuration table indicated by the row index value and the column index value may indicate SRS bandwidth (e.g., for every transmission), SRS bandwidth location within a bandwidth part per SRS transmission, and/or other frequency hopping related parameters. The third frequency domain hopping parameter (e.g., the freqHopping.b-hop parameter) may indicate whether frequency hopping is enabled, a quantity of frequency hops, and/or an offset associated with frequency hopping, among other examples.

In some examples, partial frequency sounding (PFS) may be enabled (e.g., in addition to SRS frequency hopping enabling) to improve SRS capacity and/or coverage. For example, to improve SRS capacity and enable multiplexing more SRS ports/UEs, the UE may be configured to sound only a subset of contiguous resource blocks from the configured SRS BW per SRS transmission or hop. A partial frequency (PF) parameter (e.g., a PartialFrequency.PF parameter) may indicate that an SRS bandwidth indicated by the frequencyHopping.c-SRS parameter and frequencyHopping.b-SRS parameter will be scaled by a value (e.g., PF), where a value of 1 indicates that partial frequency sounding is disabled. A second parameter (e.g., a PartialFrequency.KF parameter) may indicate a starting sub hop (or start RB) of the partial SRS bandwidth per frequency hop period. The starting RB of SRS PFS can be changed over frequency hopping periods. This enables the UE to sound the other RBs across multiple frequency hopping periods.

In some examples, a change in a single frequency domain parameter may require a change in other frequency domain parameters. For example, a change in a value or information associated with the transmission combination parameter may necessitate a change or reconfiguration of the transmission combination offset parameter. As another example, a change in the first frequency domain hopping parameter (e.g., the freqHopping.c-SRS parameter) may necessitate a change or reconfiguration of the second frequency domain hopping parameter (e.g., the freqHopping.b-SRS parameter) and/or the third frequency domain hopping parameter (e.g., the freqHopping.b-hop parameter). For example, as described above, multiple frequency domain parameters may be used in combination to indicate frequency domain information associated with an SRS resource. Therefore, modifying and/or reconfiguring frequency domain parameters associated with an SRS resource and/or SRS resource set may be a burdensome task.

As indicated above, FIG. 5 is provided as an example. Other examples may differ from what is described with regard to FIG. 5.

As described above, an SRS may be used for uplink channel estimation, which in turn may be used for scheduling, link adaptation, precoder selection, or beam management, among other examples, by a network entity. In some wireless communication systems, such as a 5G NR wireless communication system, a UE may include an increased quantity of antennas or antenna ports (e.g., as compared to deployments of UEs associated with earlier wireless communication systems) to enable spatial precoding/beamforming, and/or an increased uplink data capacity, among other examples. As a result, an increased quantity of resources (e.g., time domain resources and/or frequency domain resources) may be needed for SRS transmissions because the UE may need to transmit multiple SRSs to sound channels associated with each antenna, each antenna element, and/or each antenna panel associated with the UE.

Additionally, advancements in wireless communication technology have enabled a cell capacity (e.g., a quantity of UEs that can be supported in a single cell) to be increased and for cell coverage (e.g., a geographic area associated with a single cell) to be increased. As a result, an overhead associated with uplink channel estimations and/or SRS signaling has increased. For example, massive MIMO scenarios may be associated with an increased overhead associated with uplink channel estimations (e.g., by a network entity via SRS uplink transmissions). For example, a network entity may be required to perform simultaneous uplink channel estimations for multiple UEs (e.g., included in a group associated with co-scheduling). Further, enhanced support for mobility of UEs (e.g., with limited degradation in service quality for the mobile UEs) may require in increased rate of channel estimations or updates performed by the network entity.

As a result, a signaling overhead associated with SRS transmissions (e.g., a quantity of time domain and/or frequency domain resources used for SRS transmissions) may be increased in such wireless communication systems to accommodate increased quantities of UE antennas or antenna ports, increased cell capacity, increased cell coverage, and/or enhanced UE mobility support, among other examples. Therefore, the network (e.g., a network entity) may need to allocate more resources (e.g., time domain resources and/or frequency domain resources) for SRS transmissions that would have otherwise been used for other uplink transmissions or downlink transmissions. This may decrease a throughput (or link capacity) associated with communications between the network (e.g., a network entity) and a UE or equivalently the overall cell capacity can be limited because of the increased SRS overhead in the cell Thus, a smart trade off should be managed by the network (e.g., by a network entity) for overall cell capacity optimizations.

Different mobile UE terminals have different speed, SNR, channel characteristics, location (e.g., located at cell edge or not located at a cell edge) at different time moments. Channel estimation and tracking (e.g., channel refresh) requirements depend on UE speed, UE SNR and number of layers for UE transmission. Correspondingly, a different time domain and/or frequency domain SRS patterns would be ideally required for different UE speeds, SNRs and channel types such that the overall link quality of a UE would not be limited by channel estimation and tracking accuracy from one side, and an unnecessary SRS allocations that consume uplink resources would be avoided from the other side. Thus, SRS resources allocations (e.g., bandwidth, density in frequency domain, allocation rate in time domain/periodicity) for required uplink channel estimations may be based on a UE speed, SNR, channel characteristics, and/or UE geographic location (e.g., whether the UE is near a cell edge), among other examples. Correspondingly, the required SRS allocations and/or SRS signaling overhead associated with uplink channel estimations may be determined dynamically and may change for a given UE over time. Therefore, an amount of SRS resources needed for a given UE (e.g., to be used by the UE to transmit SRSs that are measured by a network entity for uplink channel estimations) may change over time. Furthermore, a quantity of UEs within a cell (e.g., communicating with a network entity) may change over time. Therefore, different SRS configurations for the network (e.g., corresponding to a different SRS overhead level or threshold) may be acceptable at different times (e.g., in scenarios where fewer UEs are connected to a network entity. the network entity may configure the connected UEs to use a higher SRS transmissions volume and/or overhead or a larger bandwidth or a higher rate for transmitting SRSs).

Given the above considerations, in order to be able to get to an optimal tradeoff between SRS overhead and possible capacity increase and/or link quality in a cell (e.g., due to an increased volume of SRS transmissions), it will be beneficial to use a dynamic SRS pattern per UE adaptive to UE speed, SNR, channel conditions, scheduling scenario and NW loading. As a result, SRS configurations may be determined dynamically by the network for different UEs over time. However, in some cases, reconfiguration of one or more SRS resource sets for a UE may be a burdensome and lengthy procedure. For example, to change the configuration of the SRS resource set, the network entity may use RRC reconfiguration procedures. Dynamic RRC based SRS reconfiguration (e.g., that is associated with a high latency and is not a synchronized procedure between UE and network) may not be a suitable option dynamic reconfiguration “on the fly.”

For aperiodic SRS resource sets, while the aperiodic SRS resource set may be dynamically triggered by the network entity (e.g., in a DCI message), the network entity may use an RRC reconfiguration between the triggering events to change some SRS parameters including time domain and/or frequency domain resources or patterns associated with the aperiodic SRS resource set, however this introduces scheduling limitations for aperiodic SRS during a time period that may be involved in RRC reconfiguration procedures (e.g., in some cases can be several hundreds of milliseconds). As described above, RRC reconfiguration procedures are associated with high latency and are not synchronous (e.g., there may be ambiguity as to a time at which the UE and network entity are to switch to using new configuration indicated by the RRC reconfiguration). Therefore, dynamic RRC reconfiguration of SRS resource sets may not be practical. As a result, the UE and network entity may communicate using an SRS resource set that is associated with a static configuration that is not optimized for current cell conditions or cell load, scheduling scenario, channel conditions, and/or UE conditions, among other examples. This may result in the UE unnecessarily consuming resources (e.g., time domain resources and/or frequency domain resources) associated with transmitting SRSs using a static configuration (including the frequency domain pattern configuration) associated with the SRS resources and/or SRS resource set.

Some techniques and apparatuses described herein enable dynamic adaptation and/or reconfiguration of SRS frequency domain parameters (e.g., configuration parameters associated with indicating a frequency domain pattern for an SRS resource and/or an SRS resource set). In some aspects, a network entity may configure, for a UE, an SRS resource set (e.g., and corresponding SRS resources) associated with one or more frequency domain parameters. For example, the network entity may transmit, and the UE may receive, an SRS configuration, associated with an SRS resources and/or SRS resource set, indicating information (e.g., values, index values, and/or other information) for a set of one or more frequency domain parameters associated with the SRS resource set (e.g., and the corresponding SRS resources). The network entity may transmit, and the UE may receive, a message indicating modified information (modified configuration or a dynamic reconfiguration) for a subset of (e.g., one or more) frequency domain parameters, from the set of one or more frequency domain parameters, associated with at least one SRS resource associated with the SRS resource set (e.g., the dynamic reconfiguration of the frequency domain parameters may be an a per-SRS resource basis or a per-SRS resource set basis). In other words, the network entity may transmit a message that dynamically modifies configuration for one or more frequency domain parameters (e.g., RRC parameters) for the SRS resource set (e.g., and all related SRS resources) and/or for individual SRS resources associated with the SRS resource set. The message may be a MAC-CE message or a DCI message, among other examples. The SRS resource set may be an aperiodic SRS resource set, a periodic SRS resource set, or a semi-persistent SRS resource set.

As a result, the network entity may be enabled to dynamically adapt or change one or more frequency domain parameters for an SRS resource set over time. For example, the network entity may be enabled to dynamically adapt a frequency domain pattern or density associated with a given SRS resource set (SRS resources). Therefore, the network entity and the UE may conserve resources (e.g., frequency domain resources) that would have otherwise been associated with communicating SRSs using SRS resources that do not have an optimized frequency domain configuration for current cell conditions or cell load, scheduling scenario, channel conditions, and/or UE conditions, among other examples.

FIG. 6 is a diagram of an example 600 associated with dynamic adaptation of SRS frequency domain parameters, in accordance with the present disclosure. As shown in FIG. 6, a network entity 605 (e.g., a base station 110, a CU 310, a DU 330, and/or an RU 340, among other examples) may communicate with a UE (e.g., the UE 120). In some aspects, the network entity 605 and the UE 120 may be part of a wireless network (e.g., the wireless network 100). The UE 120 and the network entity 605 may have established a wireless connection prior to operations shown in FIG. 6.

As shown by reference number 610, the network entity 605 may transmit, and the UE 120 may receive, configuration information. In some aspects, the UE 120 may receive the configuration information via one or more of RRC signaling, one or more MAC-CEs, and/or DCI, among other examples. In some aspects, the configuration information may include an indication (e.g., an implicit indication) of one or more configuration parameters (e.g., stored by the UE 120 and/or previously indicated by the network entity 605 or other network device) for selection by the UE 120, and/or explicit configuration information for the UE 120 to use to configure the UE 120, among other examples. For example, a DU or a CU may determine the configuration information and an RU may transmit the configuration information to the UE 120. The DU or the CU may transmit the configuration information to the RU.

In some aspects, the configuration information may include an SRS configuration. The SRS configuration may configure one or more SRS resource sets (e.g., in a similar manner as described in more detail elsewhere herein). For example, the SRS configuration may configure an SRS resource set and one or more SRS resources associated with the SRS resource set. The SRS configuration may indicate (e.g., in an SRSResourceSet.Usage information element) a usage type associated with the SRS resource set (e.g., the SRS resource set may be associated with a use case of antenna switching, codebook, non-codebook, or beam management, among other examples). Additionally, or alternatively, the SRS configuration may indicate that the SRS resource set is a periodic SRS resource set, a semi-persistent SRS resource set, or an aperiodic SRS resource set. The SRS configuration may be an RRC configuration. For example, the network entity 605 may transmit, and the UE 120 may receive, an indication of the SRS configuration via an RRC message. In some aspects, the configuration information may partially be indicated by another message. For example, for an aperiodic SRS resource set (and aperiodic SRS resources included in the SRS resource set), the network entity 605 may transmit DCI triggering the aperiodic SRS resource set, where the DCI at least partially indicates the configuration information. Similarly, the configuration information may be partially indicated by a MAC-CE message (e.g., for semi-persistent SRS resources).

In some aspects, the configuration information may indicate one or more SRS resource identifiers. For example, the configuration information may indicate one or more SRS resource identifiers in an SRS-ResourceIDList information element. In some aspects, the configuration information may indicate multiple SRS resource identifiers (e.g., for each SRS resource or symbol associated with the SRS resource set). In some other aspects, the configuration information may indicate a single SRS resource identifier that is associated with multiple SRS symbols.

The SRS configuration may indicate a time domain configuration and/or a frequency domain configuration associated with the SRS resource set (e.g., and related SRS resources). For example, the SRS configuration may indicate information (e.g., configuration information, values, indices, and/or code points, among other examples) for a set of one or more frequency domain parameters associated with the SRS resource and/or SRS resource set. The information for the set of one or more frequency domain parameters may indicate a frequency domain configuration and/or a frequency domain pattern associated with the SRS resources. For example, the information for the set of one or more frequency domain parameters may indicate frequency domain resources (e.g., subchannels or resource elements) to be associated with the one or more SRS resources and SRS transmissions. For example, the set of one or more frequency domain parameters may include a transmission combination parameter (e.g., a transmissionComb RRC parameter) associated with a frequency domain density. a transmission combination offset parameter (e.g., a combOffset RRC parameter), a frequency domain shift parameter (e.g., a freqDomainShift RRC parameter), a frequency domain position parameter (e.g., a freqDomainPosition RRC parameter), a first frequency domain hopping parameter (e.g., a freqHopping.c-SRS RRC parameter) associated with an SRS bandwidth configuration row index value, a second frequency domain hopping parameter (e.g., a freqHopping.b-SRS RRC parameter) associated with an SRS bandwidth configuration column index value, a third frequency domain hopping parameter (e.g., a freqHopping.b-hop RRC parameter) associated with at least one of indicating whether frequency hopping is enabled, a quantity of frequency hops, or an offset associated with frequency hopping, and/or one or more partial frequency sounding parameters (e.g., a PartialFrequency.PF RRC parameter and/or a PartialFrequency.KF RRC parameter), among other examples. In this way, the network entity 605 may configure frequency domain information associated with the SRS resource set (e.g., and SRS resources associated with the SRS resource set).

The network entity 605 may determine the SRS configuration. For example, a base station, CU, and/or DU may determine the SRS configuration. In some aspects, the network entity 605 may determine the SRS configuration based at least on a carrier frequency, a subcarrier spacing, a type of deployment, cell loading, scheduling scenario, a UE channel condition (e.g., SNR, delay spread, and/or a Doppler parameter), a UE channel type, a geographic location of the UE 120, and/or movement information associated with the UE 120 (e.g., a speed of the UE 120, an acceleration of the UE 120, and/or a direction of travel of the UE 120), among other examples. In some aspects, the network entity 605 may adaptively determine the SRS configuration to optimize frequency domain resources used by the UE 120 to transmit SRSs based at least on information (e.g., described above) at a time when, or slightly before, the SRS configuration is transmitted to the UE 120.

The UE 120 may configure the UE 120 based at least on the configuration information. In some aspects, the UE 120 may be configured to perform one or more operations described herein based at least on the configuration information.

In some aspects, the UE 120 may transmit, and the network entity 605 may receive, a capabilities report. For example, the UE 120 may transmit, to an RU, the capabilities report. The RU may transmit, to a DU, an indication of the capabilities report. In some aspects, the capabilities report may indicate UE support for dynamically adopting configuration parameters for SRS, as described in more detail elsewhere herein. For example, the capabilities report may indicate that the UE 120 is capable of dynamically adapting information or a configuration of one or more frequency domain parameters associated with SRS resources, as described in more detail elsewhere herein. In some aspects, the network entity 605 may dynamically adapt one or more frequency domain parameters, as described in more detail elsewhere herein, based at least on the capabilities report indicating that the UE 120 supports dynamic adaptation of frequency domain parameters associated with SRS resource sets.

In some aspects (e.g., for aperiodic SRS adaptation), as shown by reference number 615, the network entity 605 may transmit, and the UE 120 may receive, a message activating one or more SRS trigger states. For example, the configuration information (e.g., an RRC configuration) may configure a set of SRS trigger states. For example, the UE 120 may receive, from the network entity 605, an RRC configuration of multiple SRS trigger states associated with a given SRS resource set (e.g., a given aperiodic SRS resource set). The multiple SRS trigger states may be associated with different respective configurations for the set of one or more frequency domain parameters for the SRS resources linked to the SRS resource set. The UE 120 may receive, from the network entity 605, a MAC-CE message (e.g., synchronous and low latency signaling) activating one or more SRS trigger states. The MAC-CE message may indicate an association of (e.g., a mapping of) the one or more SRS trigger states to code points (e.g., index values) of an SRS request field of a DCI message. In this way, by configuring and dynamically activating or deactivating multiple SRS trigger states associated with the same SRS resource set (e.g., for an aperiodic SRS resource set) but with a different configuration for the SRS resource set, the network entity 605 may be enabled to dynamically adapt frequency domain configurations to be used by the UE 120 associated with different triggering events for the aperiodic SRS resource set transmissions, as explained in more detail elsewhere herein.

As shown by reference number 620, the network entity 605 may determine a modification for one or more frequency domain parameters associated with the SRS (e.g., for one or more (or all) SRS resources associated with the SRS resource set). For example, the network entity 605 may determine modified information for one or more (or all) frequency domain parameters, from the set of one or more frequency domain parameters, associated with the SRS resource set. In other words, the network entity 605 may determine a modified configuration, or a reconfiguration, for the one or more frequency domain parameters. In some aspects, the network entity 605 may determine a modified frequency domain pattern to be associated with the SRS resource set (e.g., and related SRS resources), a modified SRS bandwidth or bandwidth location within the corresponding BWP to be associated with the SRS, a modified frequency hopping configuration to be associated with the SRS, and/or a modified partial frequency sounding configuration to be associated with the SRS, among other examples.

In some aspects, the network entity 605 may determine the modification and/or the modified information based at least on some characteristics or information that has changed since a time at which the configuration information (e.g., the SRS configuration) was transmitted to the UE 120. For example, the network entity 605 may determine the modification and/or the modified information based at least on a current SNR of a channel between the UE 120 and the network entity 605, a channel type or channel delay spread characteristics or channel frequency response characteristics, a speed of the UE 120, an geographic location of the UE 120 (e.g., near a cell edge), a data volume associated with the UE 120 (e.g., an amount, or size, of data communicated between the UE 120 and the network entity 605), a quantity of UEs being served by the network entity, and/or a co-scheduling determination (e.g., associated with uplink massive MIMO scenarios), or a scheduling regime/scenario for a UE among other examples.

As shown by reference number 625, the network entity 605 (e.g., a base station 110 or an RU) may transmit, and the UE 120 may receive, a message indicating the modified information for the one or more frequency domain parameters, from the set of one or more frequency domain parameters, associated with the SRS resources associated with the SRS resource set. For example, rather than reconfiguring the SRS resources associated with the SRS set via an RRC reconfiguration procedure (e.g., non-synchronous and with a high latency), the network entity 605 may dynamically adapt information for the one or more (or all) frequency domain parameters associated with the SRS resource set (e.g., via dynamically reconfiguring the SRS resources), as described in more detail elsewhere herein. The one or more frequency domain parameters (e.g., that are dynamically adapted or modified for a periodic SRS resource set, a semi-persistent SRS resource set, or an aperiodic SRS resource set) may include the transmission combination parameter (e.g., a transmissionComb RRC parameter) associated with a frequency domain density, the transmission combination offset parameter (e.g., a combOffset RRC parameter), the frequency domain shift parameter (e.g., a freqDomainShift RRC parameter), the frequency domain position parameter (e.g., a freqDomainPosition RRC parameter), the first frequency domain hopping parameter (e.g., a freqHopping.c-SRS RRC parameter) associated with an SRS bandwidth configuration row index value, a second frequency domain hopping parameter (e.g., a freqHopping.b-SRS RRC parameter) associated with an SRS bandwidth configuration column index value, the third frequency domain hopping parameter (e.g., a freqHopping.b-hop RRC parameter) associated with at least one of indicating whether frequency hopping is enabled, a quantity of frequency hops, or an offset associated with frequency hopping, and/or the one or more partial frequency sounding parameters (e.g., a PartialFrequency.PF RRC parameter and/or a PartialFrequency.KF RRC parameter), among other examples.

In some aspects, when a given frequency domain parameter is modified or adapted, all frequency domain parameters in a subset (e.g., one or more) of frequency domain parameters that include the given frequency domain parameter may also be modified or adapted. For example, in some cases, when a given frequency domain parameter is modified or adapted, one or more other frequency domain parameters may also necessarily need to be modified or adapted. A first example subset of one or more frequency domain parameters may include the transmission combination parameter (e.g., the transmissionComb RRC parameter) and the transmission combination offset parameter (e.g., the combOffset RRC parameter). For example, information associated with frequency domain parameters included in the first example subset may impact an SRS density or pattern in the frequency domain and specific resource elements occupied by each SRS port within a given resource block. Therefore, the frequency domain parameters included in the first example subset may be dynamically adapted together to ensure that complete information for the SRS density or pattern in the frequency domain and specific resource elements occupied by each SRS port within a given resource block is provided for the UE 120. In some aspects, the first example subset of one or more frequency domain parameters may include a cyclic shift parameter (e.g., a transmissionComb.cyclicShift RRC parameter).

Dynamic adaptation, modification, and/or reconfiguration of the frequency domain parameters included in the first example subset may provide one or more benefits. For example, the network entity 605 may be enabled to dynamically adjust an SRS capacity within a cell. For example, the quantity of frequency domain multiplexed SRS transmissions can be increased with a higher comb (e.g., a higher value for the transmissionComb RRC parameter) and/or a modified frequency domain density or pattern for various UEs included in the cell. As another example, the network entity 605 may be enabled to reduce a signaling overhead associated with SRSs by dynamically adjusting the SRS resolution or density in the frequency domain for different UEs (e.g., including for the UE 120) based at least on a channel correlation in the frequency domain or time domain, a channel type, and/or an SNR associated with each UE, among other examples. For example, the network entity 605 may be enabled to dynamically indicate to the UE 120 to use a minimum acceptable SRS resolution or density in the frequency domain (e.g., to allow a sufficient SRS based uplink channel estimation accuracy for a given UE channel and SNR conditions). The released resources (e.g., the resources no longer used for SRS transmission by the UE 120) may allow a higher density SRS for other UEs that may require a higher SRS density to support a higher channel estimation accuracy requirement for these other UEs. Channel and/or SNR characteristics are dynamic in time per UE and the dynamic adaptation, modification, and/or reconfiguration of the frequency domain parameters included in the first example subset may enable the network entity 605 to reconfigure the transmissionComb RRC parameter and/or the combOffset RRC parameter over time for different UEs as this information changes to optimize or to a more efficiently distribute the frequency domain resources used by the UEs to transmit SRSs.

For example, if the UE 120 is associated with a channel having a lower frequency selectiveness, the network entity 605 may indicate that the transmissionComb RRC parameter may be associated with a higher value (e.g., 4, 8, or a higher value) at least until the UE SNR satisfies a first threshold. In contrast, if the UE 120 is associated with a channel having a higher frequency selectiveness, the network entity 605 may indicate that the transmissionComb RRC parameter is associated with a lower value (e.g., 2 or another value) at least until the UE SNR satisfies a second threshold. Additionally, if the UE 120 is associated with a higher SNR value, the uplink channel estimation may be more sensitive to channel frequency interpolation errors or floors that may be introduced and may impact SRS-based PMI, RI, and/or MCS selections. Therefore, in such examples, a transmissionComb RRC parameter associated with a lower value (e.g., 2 or another value) may be needed to efficiently exploit the higher SNR characteristic for the UE link. As another example, if the UE 120 is associated with a lower SNR value, then the UE 120 may be thermal noise limited for SRS processing and a higher SRS based channel interpolation error floor may be acceptable, such that the UE 120 can be configured with a higher transmissionComb parameter value. In this case, (e.g., a thermal noise limited scenario) it may be possible to improve SRS processing gain using a higher SRS transmission power/boosting on the relevant resource elements coupled to a higher transmissionComb usage.

As another example, high mobility UEs may be more sensitive to channel tracking or interpolation errors in the time domain as compared to channel estimation or interpolation errors in the frequency domain. Therefore, the network entity 605 may balance between an SRS frequency domain resolution/pattern of the SRS resource set (e.g., a transmissionComb parameter value) and a time domain resolution/pattern of the SRS resource set as a function of UE-specific Doppler, Delay spread and SNR parameters while also keeping the constant SRS resources budget per UE to enable optimal utilization of the SRS capacity associated with the UE 120.

As another example, the network entity 605 may be enabled to improve SRS coverage by dynamically increasing a value associated with the transmissionComb parameter (e.g., and correspondingly indicating a power boost for each resource element used for a transmission of the SRS). For example, when a UE 120 is located near a cell edge, the network entity 605 may dynamically increase a value associated with the transmissionComb parameter to improve SRS coverage associated with the UE 120. This may enable the UE 120 to concentrate SRS energy for channel estimation in examples where the UE 120 is thermal noise limited and not sensitive to frequency interpolation error floor (e.g., the network entity 605 may dynamically adapt the UE 120 to use less dense resource elements associated with a higher transmit power or boosting value instead of relying on channel estimation processing gain coming from a denser allocated resource element pattern). As another example, the network entity 605 may be enabled to reduce SRS interference and/or collisions between different cells when the UE 120 is located near a cell edge. For example, the network entity 605 may dynamically select and indicate values for the transmissionComb RRC parameter and/or the combOffset RRC parameter (or a cyclic shift option) to avoid interference and/or collisions with SRS transmissions from a neighboring cell. For example, when the UE 120 is located near a cell edge with a second cell, the network entity 605 may dynamically select and indicate values for the transmissionComb RRC parameter and/or the combOffset RRC parameter (or a cyclic shift option) such that the UE 120 transmits SRSs using REs that are different than REs used by cell edge UEs, included in the second cell, to transmit SRSs.

As another example, the network entity 605 may be enabled to reduce inter-carrier interference (ICI) for frequency domain multiplexed SRS transmissions of two UEs associated with different SNR channel characteristics. For example, ICI caused by a stronger SRS signal (e.g., from a UE associated with a higher SNR channel characteristic) to a weaker SRS signal (e.g., from a UE associated with a lower SNR channel characteristic) can be reduced by a proper combOffset RRC parameter and/or transmissionComb RRC parameter value selection for the two UEs. For example, an SRS transmission from a first UE that is associated with a high transmit phase noise (e.g., associated with a higher carrier frequency, such as FR2 or sub-terahertz frequencies) or a high frequency offset may cause ICI for an SRS transmission from a second UE that is associated with a lower SNR value. Therefore, the network entity 605 may dynamically adapt the transmissionComb RRC parameter and/or combOffset RRC parameter values for the first UE and the second UE to reduce the ICI.

The dynamic adaptation and/or modification of frequency domain parameters included in the first example subset may enable higher values for the transmission combination parameter, such as 8 or 16, that may be applicable to SRS resource sets and/or SRS resources associated with any SRS usage type. For example, currently, the higher values for the transmission combination parameter may be restricted to certain usage types. However, by enabling the dynamic adaptation and/or modification of frequency domain parameters as described herein, the higher values may be used for SRS resource sets associated with any SRS usage type.

A second example subset of one or more frequency domain parameters may include the frequency domain shift parameter (e.g., the freqDomainShift RRC parameter), the frequency domain position parameter (e.g., the freqDomainPosition RRC parameter), the first frequency domain hopping parameter (e.g., the freqHopping.c-SRS RRC parameter), the second frequency domain hopping parameter (e.g., the freqHopping.b-SRS RRC parameter), the third frequency domain hopping parameter (e.g., the freqHopping.b-hop RRC parameter), and the one or more partial frequency sounding parameters (e.g., the PartialFrequency.PF RRC parameter and/or the PartialFrequency.KF RRC parameter). For example, information associated with frequency domain parameters included in the second example subset may impact a bandwidth of a given SRS transmission, a range of resource elements associated within a corresponding bandwidth part associated with a given SRS transmission, and frequency hopping parametrization for SRS transmission(s). A third example subset of one or more frequency domain parameters may include the frequency domain position parameter (e.g., the freqDomainPosition RRC parameter), the first frequency domain hopping parameter (e.g., the freqHopping.c-SRS RRC parameter), the second frequency domain hopping parameter (e.g., the freqHopping.b-SRS RRC parameter), and the third frequency domain hopping parameter (e.g., the freqHopping.b-hop RRC parameter). For example, the information indicated by frequency domain parameters included in the third and/or fourth example subsets may in combination indicate resource elements to be associated with a given SRS transmission. Therefore, the subsets of parameters may necessarily need to be dynamically adapted and/or reconfigured together.

A fourth example subset of one or more frequency domain parameters may include the frequency domain shift parameter (e.g., the freqDomainShift RRC parameter). For example, in some cases, the frequency domain shift parameter may be dynamically adapted or reconfigured independently. A fifth example subset of one or more frequency domain parameters may include the first frequency domain hopping parameter (e.g., the freqHopping.c-SRS RRC parameter), the second frequency domain hopping parameter (e.g., the freqHopping.b-SRS RRC parameter), and the PartialFrequency.PF RRC parameter. For example, any change in the parameters included in the fifth example subset may also impact location of a given SRS transmission (e.g., in the frequency domain), and may impact frequency hopping applicability (e.g., whether frequency hopping is enabled or disabled) and frequency hopping related parameters. A sixth example subset of one or more frequency domain parameters may include the one or more partial frequency sounding parameters (e.g., the PartialFrequency.PF RRC parameter and/or the PartialFrequency.KF RRC parameter). For example, parameters associated with partial frequency sounding may be dynamically adapted and/or reconfigured together.

Dynamic adaptation, modification, and/or reconfiguration of the frequency domain parameters included in the second, third, fourth, fifth, and/or sixth example subsets may provide one or more benefits. For example, the network entity 605 may be enabled to dynamically select a subband for downlink and/or uplink allocations for the UE 120 (e.g., and correspondingly the related SRS transmission, such as for antenna switching use cases, non-codebook use cases, and/or codebook use cases). For example, the network entity 605 may identify a resource element subband or range based at least on a sub band (SB) channel state feedback (CSF) report transmitted by the UE 120. For example, the network entity 605 may dynamically increase or decrease a bandwidth or change a bandwidth location associated with an SRS transmission by dynamically adapting parameters included in the second, third, fourth, fifth, and/or sixth example subsets. Dynamic subband selection may improve scheduling and/or interference mitigation operations performed by the network entity 605.

As another example, modification and/or reconfiguration of the frequency domain parameters included in the second, third, fourth, fifth, and/or sixth example subsets may enable dynamic selection of an SRS bandwidth for a given SRS transmission and/or an overall frequency range associated with SRS frequency hopping. For example, UEs located at a cell edge or that are limited in an available transmit power may be dynamically adapted to use a smaller SRS bandwidth for a given SRS transmission (e.g., to concentrate a transmission power over a smaller frequency range) and to use frequency hopping to cover a wider or required bandwidth across frequency hopping period (e.g., to improve SNR on the resource elements used to transmit the SRSs for every frequency hop). Alternatively, UEs having better SNR values and/or with more available uplink transmit power may be dynamically adapted to use a larger bandwidth and to not use frequency hopping (e.g., to reduce SRS periodicity and/or to improve an SRS-based channel tracking rate).

As another example, modification and/or reconfiguration of the frequency domain parameters included in the second, third, fourth, fifth, and/or sixth example subsets may enable the network entity 605 to dynamically indicate different frequency hopping parameter values and/or to dynamically enable or disable frequency hopping for a given SRS resource set. For example, different frequency hopping parameters can be used for the SRS resource set based on UE mobility to adjust the rate of a channel refresh/tracking over the full relevant channel bandwidth (e.g., a lower quantity of frequency hops or no frequency hopping will effectively increase the rate of channel refresh). As another example, modification and/or reconfiguration of the frequency domain parameters included in the second, third, fourth, fifth, and/or sixth example subsets may enable the network entity 605 to dynamically adapt an SRS bandwidth, subband, and/or frequency hopping usage for SRS based Doppler tracking as a function of UE uplink channel flatness. For example, in a case where the UE 120 is associated with a relatively flat channel, a smaller bandwidth may be used by the UE 120 for Doppler tracking SRS transmissions. In other cases, where the UE 120 is associated with a more frequency selective channel, a larger bandwidth may be used by the UE 120 for Doppler tracking SRS transmissions.

In some aspects, the message (e.g., that indicates the modified information for the one or more frequency domain parameters) may be included in a MAC-CE message. For example, the network entity 605 may use MAC-CE-based reconfiguration of frequency domain parameters for an SRS resource set and/or for SRS resources included in an SRS resource set (e.g., for a periodic SRS resource set, a semi-persistent SRS resource set, or an aperiodic SRS resource set). The information indicated by the MAC-CE message may be applicable to all SRS resources associated with the SRS resource set (e.g., the reconfiguration may be done per SRS resource set identifier and may be applicable for all SRS resources listed under the indicated SRS resource set identifier). In some aspects, the information indicated by the MAC-CE message may be applied by the UE 120 and/or the network entity 605 a quantity of slots (e.g., N slots) after a transmission by the UE of the corresponding acknowledgement message (ACK) message associated with the MAC-CE message. For example, as shown by reference number 630, the UE 120 may transmit an ACK message associated with a message indicating that a communication (e.g., a PDSCH) associated with the MAC-CE message was successfully decoded by the UE 120. The UE 120 and/or the network entity 605 may apply the modified information for the one or more frequency domain parameters for the SRS resource set the quantity (e.g., N) of slots after a slot in which the ACK message is transmitted. In some aspects, the information indicated by the MAC-CE message may be applicable to one or more activated SRS resource sets (or SRS resources) and one or more not activated SRS resource sets (or SRS resources).

In some aspects, the MAC-CE message indicates the modified information for the one or more frequency domain parameters. In other words, the MAC-CE message may explicitly indicate the modified information for the one or more frequency domain parameters for the SRS resource set. In some other aspects, the MAC-CE message may implicitly indicate the modified information for the one or more frequency domain parameters for the SRS resource set. For example, the UE 120 may receive (e.g., in an RRC configuration and/or via the configuration information) an indication of one or more sets of information for the one or more frequency domain parameters associated with the SRS resource set. In other words, the network entity 605 may configure one or more options for information associated with the frequency domain parameters associated with the SRS resource set (e.g., several configuration options per SRS resource or SRS resource set identifier may be listed or pre-configured by an RRC configuration). The MAC-CE message may indicate or activate one set of information for the one or more frequency domain parameters associated with the SRS resource set (e.g., from the RRC configured sets or options).

For example, the MAC-CE message may activate a set of information, from the one or more sets of information, where the set of information includes the modified information with respect to a currently activated or semi-statically configured set of information for the SRS resource set. In some aspects, one of the SRS configuration options for each SRS resource or SRS resource set identifier may be dynamically activated, selected, or indicated by the MAC-CE message. The indicated option may become the active or used SRS configuration for the relevant (indicated by the MAC-CE) SRS resource or SRS resource set until a next MAC-CE reactivation or indication. As described above, the UE 120 and/or the network entity 605 may apply the information for the frequency domain parameter(s) indicated by the set of information activated by the MAC-CE message N slots after a slot in which the ACK message associated with the PDSCH allocation carrying the MAC-CE message is transmitted by the UE 120 (e.g., as described in connection with reference number 630).

In some aspects, at least one set of information, or options, for the frequency domain parameter(s) of the SRS resource set may be defined, or otherwise fixed, by a wireless communication standard, such as the 3GPP. For example, at least one of the one or more sets of information may be defined by a wireless communication standard as a default configuration option applicable before any activating MAC-CE message (e.g., to be used by the UE 120 prior to receiving a first MAC-CE message that indicated which set of information, from the RRC configured options, is to be used by the UE 120).

For example, the network entity 605 may indicate, for a given SRS resource set, a first configuration option, a second configuration option, and a third configuration option. The first configuration option may indicate a value of 8 for the transmissionComb RRC parameter (e.g., comb8), a first SRS bandwidth, and that frequency hopping is enabled. The second configuration option may indicate a value of 2 for the transmissionComb RRC parameter (e.g., comb2), a second SRS bandwidth, and that frequency hopping is disabled. The third configuration option may indicate a value of 4 for the transmissionComb RRC parameter (e.g., comb4), a third SRS bandwidth, and that frequency hopping is enabled. The second SRS bandwidth may be larger than the third SRS bandwidth and the third SRS bandwidth may be larger than the first SRS bandwidth. The network entity may activate (e.g., via the MAC-CE message) different configuration options for the given SRS resource set under different circumstances. For example, the network entity 605 may activate the first configuration option in low SNR scenarios. The network entity 605 may activate the second configuration option in high SNR scenarios, high delay spread scenarios, and/or scenarios where the UE 120 is mobile. The network entity 605 may activate the third configuration option in high SNR scenarios, high delay spread scenarios, and/or scenarios where the UE 120 is less mobile. In this way, a size of the MAC-CE message may be reduced (e.g., because the network entity may only need to indicate a configured option, rather than all of the information for the frequency domain parameter(s)) while still enabling the network entity 605 to dynamically adapt the frequency domain parameter(s) for an SRS resource set.

In some other aspects, the message (e.g., that indicates the modified information for the one or more frequency domain parameters) may be included in a DCI message. In some aspects, the message is included in a DCI message that is not associated with data transmission scheduling (e.g., a DCI message that does not schedule a data transmission). A DCI message that is not associated with data transmission scheduling may also be referred to as a “dummy DCI.” In some aspects, the DCI message may be associated with a DCI format 1_1 or a DCI format 1_2 (e.g., as defined, or otherwise fixed, by the 3GPP). For example, a non-data scheduling DCI (e.g., using DCI format 1_1 or DCI format 1_2) may be used to indicate information for the one or more frequency domain parameters of the SRS resource set. In some other aspects, the non-data scheduling DCI message may be associated with a dedicated DCI format that is associated with modifying SRS configuration parameters. For example, a DCI format may be defined (e.g., by a wireless communication standard, such as the 3GPP) that is associated with dynamic SRS parameter adaptation.

In some aspects, the non-data scheduling DCI message may indicate the modified information for the one or more frequency domain parameters (e.g., in an explicit manner where the DCI message includes the modified information). In some other aspects, the DCI message may indicate the modified information for the one or more frequency domain parameters implicitly. For example, a table with SRS configuration parameters may be indicated by the network entity 605 (e.g., in an RRC configuration) and/or may be defined by a wireless communication standard, such as the 3GPP. The DCI message may indicate an identifier (e.g., a row index and/or a column index) of the table to indicate the modified information for the one or more frequency domain parameters. The UE 120 may identify the modified information for the one or more frequency domain parameters based at least on the identifier and the information indicated by the table.

The modified information for the one or more frequency domain parameters, indicated by the DCI message, may be associated with all SRS resources associated with the SRS resource set (e.g. may refer to a specific SRS resource set identifier). The UE 120 may confirm receipt of the modified information (e.g., the reconfiguration) associated with the SRS resource set via an ACK message associated with the non-data scheduling DCI message. For example, as shown by reference number 630, the UE 120 may transmit the corresponding ACK message indicating that the DCI message was successfully decoded by the UE 120 (e.g., instead of indicating that the corresponding scheduled PDSCH allocation was successfully decoded by the UE as may otherwise be the case). The UE 120 and/or the network entity 605 may apply the modified information for the one or more frequency domain parameters for the SRS resource set a quantity of slots (e.g., M slots) after the slot in which the ACK message is transmitted by the UE 120. The modified information may override a current RRC configuration of the one or more frequency domain parameters. The modified information indicated by the non-data scheduling DCI message may be associated with one or more active SRS resource sets and/or one or more not active (e.g., not activated) SP SRS resources and/or SRS resource sets.

In some aspects, for dynamic adaptation of frequency domain parameter(s) for an aperiodic SRS resource set, the message may be included in a DCI message that schedules a transmission of the aperiodic SRS resource set. For example, dynamic adaptation of frequency domain parameters for an aperiodic SRS resource set may be coupled with aperiodic SRS resource set triggering procedures (e.g. can be done per aperiodic SRS scheduling event). For example, the DCI message may schedule a transmission of the aperiodic SRS resource set via indicating an SRS trigger state, in an SRS request field of the DCI, that is associated with or mapped to the aperiodic SRS resource set. In some aspects, the DCI message does not schedule any UL data communications (e.g., the DCI message may be a dummy DCI). For example, the DCI message may be associated with a non-PUSCH scheduling format (e.g., a dummy DCI of format 0_1 or format 0_2 as defined by the 3GPP).

For example, the DCI message may schedule the aperiodic SRS resource set (e.g., may schedule one or more aperiodic SRS resource set) via an SRS trigger state indicated by an SRS request field. Additionally, the DCI message may indicate the modified information for the one or more frequency domain parameters for the aperiodic SRS resource set via one or more other fields of the DCI message. For example, one or more fields of the non-PUSCH scheduling format may be used to indicate (e.g., explicitly or implicitly) dynamic information for one or more frequency domain parameters. For example, a table with SRS configuration parameters may be indicated by the network entity 605 (e.g., in an RRC configuration) and/or may be defined by a wireless communication standard, such as the 3GPP. The DCI message may indicate an identifier (e.g., a row index and/or a column index) of the table (e.g., in the one or more other fields of the DCI message) to implicitly indicate the modified information for the one or more frequency domain parameters. For example, the DCI message may indicate one or more indices associated with a data structure that includes multiple SRS configuration options and the one or more indices correspond to the modified information. The UE 120 may identify the modified information for the one or more frequency domain parameters based at least on the identifier and the information indicated by the table. Alternatively, the one or more other fields may indicate explicit information for the one or more frequency domain parameters.

The information indicated by the non-PUSCH scheduling DCI message that schedules the transmission of the aperiodic SRS resource set may apply to all SRS resources associated with the aperiodic SRS resource set. In some aspects, the SRS trigger state (e.g., indicated by the SRS request field of the DCI message) schedules multiple aperiodic SRS resource sets including the aperiodic SRS resource set. In some aspects, the DCI message indicates respective modified information for the one or more frequency domain parameters for each of the multiple triggered aperiodic SRS resource sets. For example, information for frequency domain parameters may be indicated separately for each one of the triggered or scheduled SRS resource set identifiers. Alternatively, the modified information for the one or more frequency domain parameters may be associated with each of the multiple aperiodic SRS resource sets. For example, information for frequency domain parameters may be indicated collectively for all of the triggered or scheduled aperiodic SRS resource set identifiers. For example, a single set of information for the frequency domain parameter may be applicable to all of the triggered or scheduled aperiodic SRS resource set identifiers.

In some other aspects, the DCI message that schedules the aperiodic SRS resource set may schedule one or more data communications. For example, the DCI message may be a PUSCH or a PDSCH scheduling DCI message (e.g., using DCI format 0_1, DCI format 0_2, DCI format 1_1, or DCI format 1_2, among other examples). As described above in connection with reference number 615, the UE 120 may receive an RRC configuration of multiple SRS trigger states associated with the SRS resource set, where the multiple SRS trigger states are associated with different respective configurations for the set of one or more frequency domain parameters for the SRS resource set. In other words, multiple SRS trigger states may be configured for the same aperiodic SRS resource set, where each of the multiple SRS trigger states are associated with different frequency domain configurations for the same aperiodic SRS resource set. Because the DCI message may schedule one or more data communications, additional fields may not be available in the DCI to indicate the information for the one or more frequency domain parameters (e.g., in contrast to the case of the non-data scheduling DCI message). Therefore, the network entity 605 may configure several frequency domain configuration options for the same SRS resource set via the SRS trigger states to provide additional flexibility to dynamically adapt or modify the frequency domain allocation, density, and/or pattern associated with the SRS resource set. The DCI message may indicate a triggered SRS trigger state, from the multiple SRS trigger states, that is associated with the information or modified configuration (e.g., determined by the network entity as described in connection with reference number 620) for the one or more frequency domain parameters of the aperiodic SRS resource set. For example, an SRS configuration option that is indicated via a scheduled SRS trigger state may override an RRC configuration (e.g., the SRS configuration) for the triggered SRS resources or SRS resource set (e.g., may dynamically reconfigure the aperiodic SRS per scheduling event).

For example, referring to the example described above including the first configuration option, the second configuration option, and the third configuration option, a first code point (e.g., 01) may be mapped to the SRS resource set and the first configuration option, a second code point (e.g., 10) may be mapped to the SRS resource set and the second configuration option, and a third code point (e.g., 11) may be mapped to the SRS resource set and the third configuration option. The network entity 605 may indicate a different codepoint in the SRS request field of the DCI message to dynamically adapt the frequency domain configuration of the given aperiodic SRS resource set per scheduling event.

As described above in connection with reference number 615, in some cases, the network entity 605 may activate one or more SRS trigger states (e.g., to reduced a quantity of activated trigger states) from a larger quantity of RRC configured SRS trigger states. The DCI message may indicate an SRS trigger state, from the list of activated SRS trigger states. For example, activating a subset of configured SRS trigger states may enable a smaller size of the SRS request field or may enable the currently used SRS request field size to be maintained while also enabling additional SRS trigger states to be configured and dynamically activated or deactivated to allow a dynamic SRS configuration adaptation by the network entity 605.

Alternatively, a field of the an extended or modified format data scheduling DCI message may indicate an index associated with a frequency domain configuration and/or one or more frequency domain parameters associated with the aperiodic SRS resource set. For example, the field may explicitly indicate the index of the frequency domain configuration and/or one or more frequency domain parameters associated with the aperiodic SRS resource set for a triggered or scheduled aperiodic SRS resource set. The field may be a bitfield. In some aspects, the field may have a size of log₂ (K), where K is the quantity (e.g., a maximum quantity) of SRS configurations to be dynamically signaled for SRS resources/SRS resource sets.

In some aspects, as shown by reference number 630, the UE 120 may transmit, and the network entity 605 may receive, an ACK message associated with the message that indicates the modified and/or reconfigured frequency domain resource parameter(s) for the SRS resource set. For example, the ACK message may be associated with a PDSCH allocation (e.g., that carries a MAC-CE message). As described above, the ACK message may be associated with a DCI message. The ACK message may indicate whether the message that indicates the modified and/or reconfigured frequency domain resource parameter(s) for the SRS resource set was successfully received and/or decoded by the UE 120.

In some aspects, the UE 120 and/or the network entity 605 may apply the modified and/or reconfigured frequency domain resource parameter(s) for the SRS resource set a quantity of slots (e.g., N slots or M slots) after the ACK message is transmitted by the UE 120. Alternatively, the UE 120 and/or the network entity 605 may apply the modified and/or reconfigured frequency domain resource parameter(s) for the SRS resource set a quantity of slots after the message that indicates the modified and/or reconfigured frequency domain resource parameter(s) for the SRS resource set is transmitted by the network entity 605.

As shown by reference number 635, the UE 120 may transmit, and the network entity 605 may receive, one or more SRSs using the modified or reconfigured information (reconfiguration) for the one or more frequency domain parameters. For example, the UE 120 may transmit an SRS, using one or more SRS resources included in the SRS resource set, in accordance with the modified information for the one or more frequency domain parameters.

As a result, the network entity 605 may be enabled to dynamically adapt or change one or more frequency domain parameters for an SRS resource set over time. For example, the network entity 605 may be enabled to dynamically adapt a frequency domain pattern or density associated with a given SRS resource set. Therefore, the network entity 605 and the UE 120 may conserve resources (e.g., frequency domain resources) that would have otherwise been associated with communicating SRSs using an SRS resource that does not have an optimized frequency domain configuration for current cell conditions, UE channel conditions, and/or UE conditions, among other examples. Additionally, the network entity 605 may dynamically adapt SRS capacity (e.g., by multiplexing more or less SRS resources in the frequency domain) to serve additional UEs in the cell while maintaining a fixed SRS overhead in the cell. As another example, RRC signaling overhead may be reduced because the SRS resources may not need an RRC reconfiguration to adapt or adjust the frequency domain parameters of the SRS resource set. Further, the network entity 605 may improve SRS coverage (e.g., for mobile UEs, UEs near a cell edge, or UEs associated with low SNR conditions). The dynamic adaptation of frequency domain parameters for an SRS resource may be associated with additional benefits as described in more detail elsewhere herein.

As indicated above, FIG. 6 is provided as an example. Other examples may differ from what is described with regard to FIG. 6.

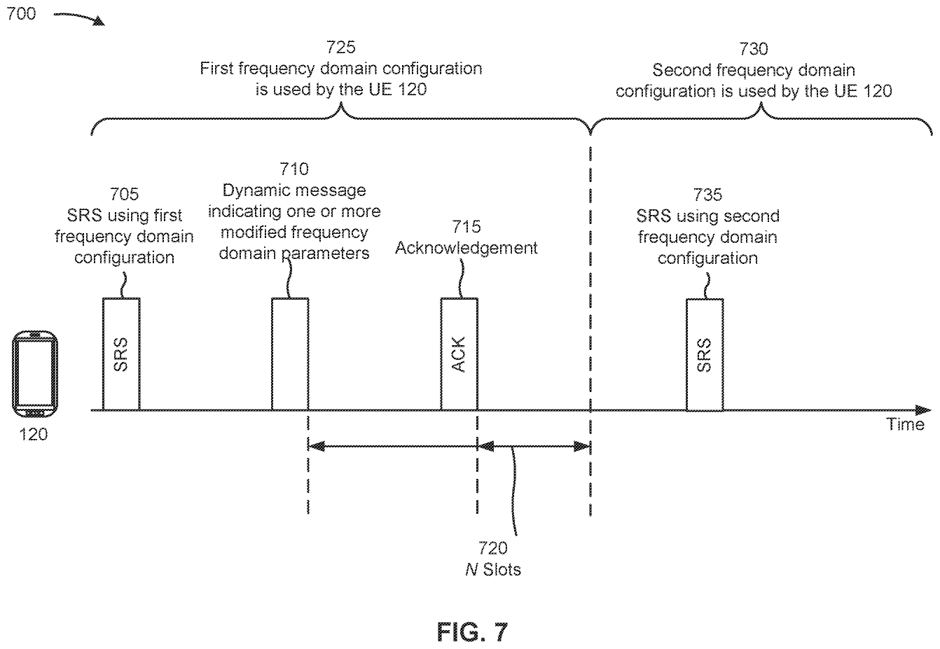

FIG. 7 is a diagram of an example 700 associated with a communication timeline for dynamic adaptation of SRS frequency domain parameters, in accordance with the present disclosure. As shown by reference number 705, the UE 120 may transmit an SRS using a first frequency domain configuration. For example, the UE 120 may transmit an SRS using information for a set of one or more frequency domain parameters associated with an SRS resource set. The information for the set of one or more frequency domain parameters may be indicated by an RRC configuration, in a similar manner as described elsewhere herein.

As shown by reference number 710, the UE 120 may receive a message indicating a dynamic reconfiguration of one or more frequency domain parameters associated with the SRS resource set. For example, the message may indicate modified information (e.g., modified from an RRC configuration) for the one or more frequency domain parameters. The UE 120 may receive the message in a similar manner as described in more detail elsewhere herein, such as in connection with FIG. 6 and/or reference number 625. For example, the message may be a MAC-CE message or a DCI message, as described above. As shown by reference number 715, the UE 120 may transmit an ACK message associated with the message that indicates the dynamic reconfiguration of one or more frequency domain parameters associated with the SRS resource set (e.g., in a similar manner as described in connection with FIG. 6 and/or reference number 630). For example, the ACK message may be associated with a PDSCH allocation associated with a MAC-CE message. As another example, the ACK message may be used to confirm the reconfiguration and/or receipt of a DCI message.

As shown by reference number 720, a quantity of slots (e.g., N slots or M slots) after a transmission of the ACK message or a reception of the message indicating the dynamic reconfiguration of the one or more frequency domain parameters, both the UE 120 and the network may apply the reconfiguration of the one or more frequency domain parameters for the SRS resource set in a synchronized way. For example, as shown by reference number 725, prior to a time indicated by the quantity of slots, the UE 120 may transmit SRSs associated with the SRS resource set using a first frequency domain configuration. As shown by reference number 730, after the time indicated by the quantity of slots, the UE 120 may transmit SRSs associated with the SRS resource set using a second frequency domain configuration. For example, as shown by reference number 735, the UE 120 may transmit an SRS, associated with the SRS resource set, using the second frequency domain configuration (e.g., indicated by the message shown by reference number 710).

As indicated above, FIG. 7 is provided as an example. Other examples may differ from what is described with regard to FIG. 7.

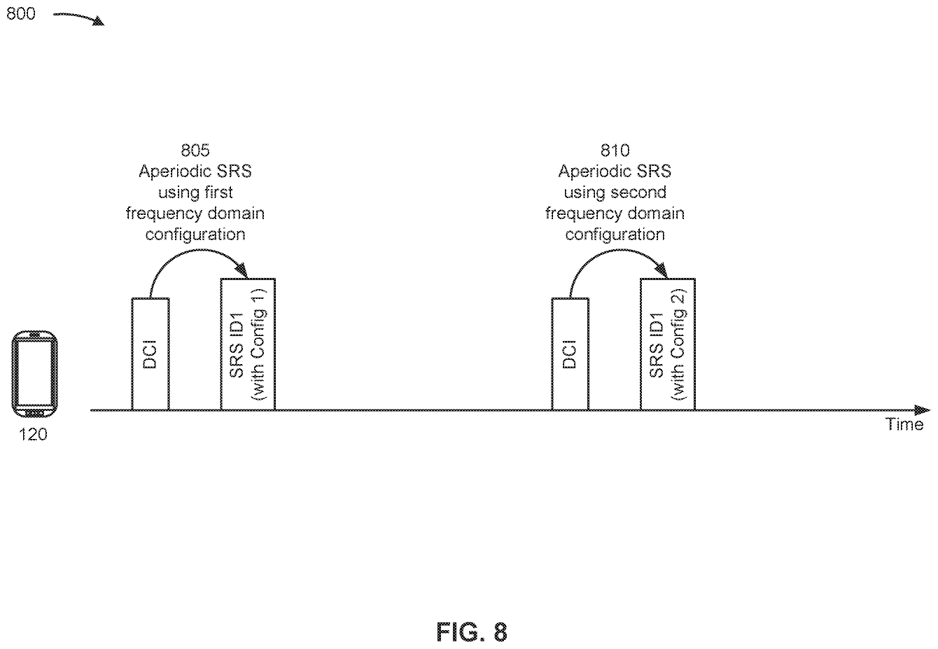

FIG. 8 is a diagram of an example 800 associated with a communication timeline for dynamic adaptation of SRS frequency domain parameters, in accordance with the present disclosure. The example 800 may be associated with aperiodic SRS resource sets. For example, in contrast, the example 700 described above may be associated with periodic SRS resource sets, semi-persistent SRS resource sets, and aperiodic SRS resource sets.

As shown by reference number 805, the UE 120 may receive a first DCI message scheduling a first transmission of one or more SRSs associated with an aperiodic SRS resource set (e.g., the SRS resource set ID1 as depicted in FIG. 8). The first DCI message may indicate a first frequency domain configuration for the aperiodic SRS resource set (e.g., in a similar manner as described in more detail elsewhere herein, such as in connection with FIG. 6 and/or reference number 625). The UE 120 may transmit one or more SRSs associated with the aperiodic SRS resource set as scheduled by the first DCI message and using on the first frequency domain configuration.

As shown by reference number 810, the UE 120 may receive a second DCI message scheduling a second transmission of one or more SRSs associated with the aperiodic SRS resource set (e.g., the SRS resource set IDI as depicted in FIG. 8). The second DCI message may indicate a second frequency domain configuration for the aperiodic SRS resource set (e.g., in a similar manner as described in more detail elsewhere herein, such as in connection with FIG. 6 and/or reference number 625). For example, the second DCI message may include explicit information for one or more frequency domain parameters that is different than information for the one or more frequency domain parameters indicated by the first DCI message. As another example, the second DCI message may indicate a different SRS trigger state, associated with the aperiodic SRS resource set, than an SRS trigger state, associated with the aperiodic SRS resource set, indicated by the first DCI message. The UE 120 may transmit one or more SRSs associated with the aperiodic SRS resource set as scheduled by the second DCI message and using on the first frequency domain configuration.

As indicated above, FIG. 8 is provided as an example. Other examples may differ from what is described with regard to FIG. 8.

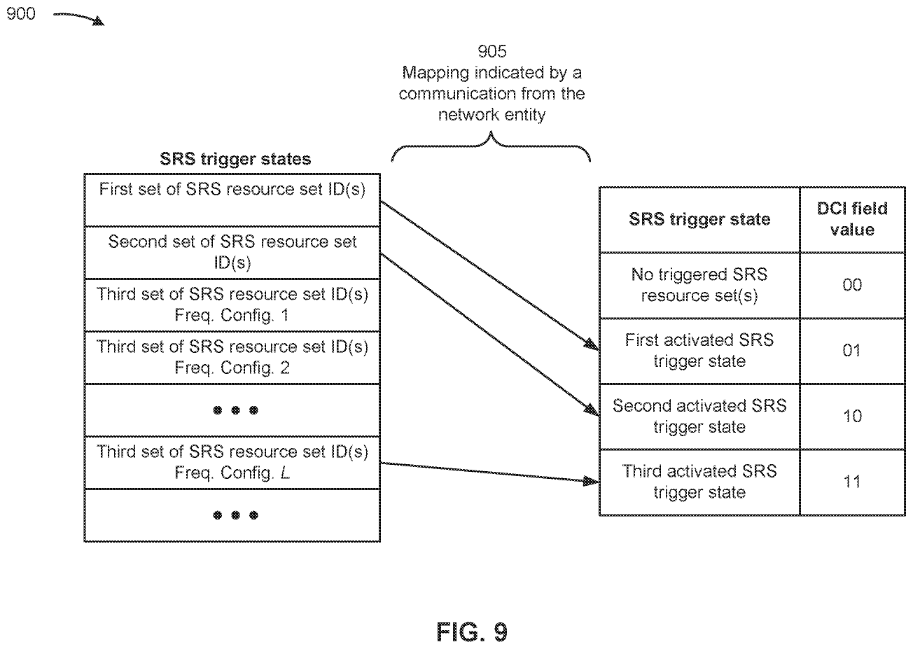

FIG. 9 is a diagram of an example 900 associated with a SRS trigger state configuration and activation for dynamic adaptation of SRS frequency domain parameters, in accordance with the present disclosure. As shown in FIG. 9, a network entity may configure a set of SRS trigger states (e.g., in an RRC configuration). For example, the network entity may configure a first trigger state associated with a first set (e.g., one or more) of SRS resource set identifiers, and a second trigger state associated with a second set (e.g., one or more) of SRS resource set identifiers. As shown in FIG. 9, the network entity may configure multiple (e.g., L) trigger states associated with a third set of SRS resource set identifiers which may be targeted for dynamic configuration adaptation. For example, a first SRS trigger state associated with the third set of SRS resource set identifiers may be associated with a first frequency domain configuration (e.g., first information for the set of one or more frequency domain parameters), a second SRS trigger state associated with the third set of SRS resource set identifiers may be associated with a second frequency domain configuration (e.g., second information for the set of one or more frequency domain parameters), and an L^{th} SRS trigger state associated with the third set of SRS resource set identifiers may be associated with an L^{th} frequency domain configuration (e.g., L^{th} information for the set of one or more frequency domain parameters). The network entity may configure additional SRS trigger states associated with other sets of SRS resource set identifiers in a similar manner.

As shown by reference number 905, the network entity may dynamically map, or associate, one or more of the configured SRS trigger states to a DCI field value (e.g., a code point associated with an SRS request field of DCI). For example, the network entity may transmit, and the UE 120 may receive, a MAC-CE message indicating one or more SRS trigger states activation/deactivation and the corresponding mapping or association of the activated trigger states with the corresponding DCI field codepoints. As shown in FIG. 9, the network entity may activate and map the first trigger state associated with the first set of SRS resource set identifiers to a first code point (e.g., 01), may activate the second trigger state associated with the second set of SRS resource set identifiers and may map the second trigger state to a second code point (e.g., 10), and may activate also the L^{th} SRS trigger state associated with the third set of SRS resource identifiers and the L-th configuration option for it and may map the L^{th} SRS trigger state to a third code point (e.g., 11). Different RRC configured SRS trigger states can be dynamically activated or deactivated over time by the network (e.g., by a network entity). For example, the network entity may be enabled to dynamically adjust activated frequency domain configuration options (from the L configuration options) for the third set of SRS resource set identifiers by adjusting which SRS trigger state(s), from the set of configured SRS trigger states associated with the third set of SRS resource set identifiers, is active or mapped to a DCI field value. In this way, the network entity may be enabled to configure multiple SRS trigger states, thereby providing flexibility and multiple configuration options for a given SRS resource set, while also minimizing the required size or maintaining a predefined size of the DCI field (e.g., the SRS request field).

As indicated above, FIG. 9 is provided as an example. Other examples may differ from what is described with regard to FIG. 9.

FIG. 10 is a diagram illustrating an example process 1000 performed, for example, by a first network node, in accordance with the present disclosure. Example process 1000 is an example where the first network node (e.g., the UE 120 or another network node) performs operations associated with dynamic adaptation of SRS frequency domain parameters.

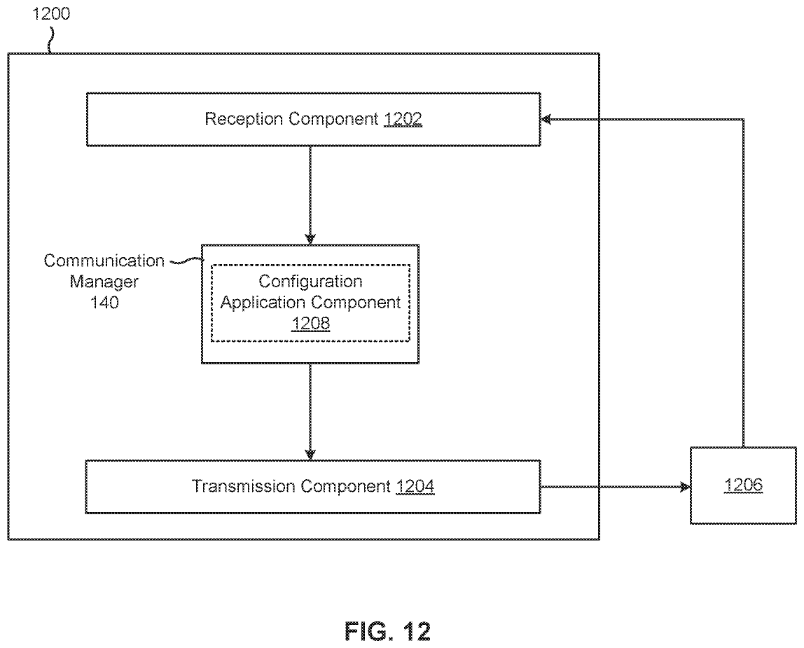

As shown in FIG. 10, in some aspects, process 1000 may include receiving, from a second network node, an SRS configuration associated with an SRS resource set including one or more SRS resources, the SRS configuration indicating information for a set of one or more frequency domain parameters associated with the SRS resource set (block 1010). For example, the first network node (e.g., using communication manager 140 and/or reception component 1202, depicted in FIG. 12) may receive, from a second network node, an SRS configuration associated with an SRS resource set including one or more SRS resources, the SRS configuration indicating information for a set of one or more frequency domain parameters associated with the SRS resource set, as described above.

As further shown in FIG. 10, in some aspects, process 1000 may include receiving, from the second network node, a message indicating modified information for a dynamic reconfiguration of one or more frequency domain parameters, from the set of one or more frequency domain parameters, associated with at least one SRS resources of the one or more SRS resources (block 1020). For example, the first network node (e.g., using communication manager 140 and/or reception component 1202, depicted in FIG. 12) may receive, from the second network node, a message indicating modified information for a dynamic reconfiguration of one or more frequency domain parameters, from the set of one or more frequency domain parameters, associated with at least one SRS resources of the one or more SRS resources, as described above.

As further shown in FIG. 10, in some aspects, process 1000 may include transmitting, to the second network node, an SRS, using the at least one SRS resource, in accordance with the modified information for the one or more frequency domain parameters (block 1030). For example, the first network node (e.g., using communication manager 140 and/or transmission component 1204, depicted in FIG. 12) may transmit, to the second network node, an SRS, using the at least one SRS resource, in accordance with the modified information for the one or more frequency domain parameters, as described above.

Process 1000 may include additional aspects, such as any single aspect or any combination of aspects described below and/or in connection with one or more other processes described elsewhere herein.

In a first aspect, the set of one or more frequency domain parameters includes at least one of a transmission combination parameter associated with a frequency domain density, a transmission combination offset parameter, a frequency domain shift parameter, a frequency domain position parameter, a first frequency domain hopping parameter associated with an SRS bandwidth configuration row index value, a second frequency domain hopping parameter associated with an SRS bandwidth configuration column index value, a third frequency domain hopping parameter associated with at least one of indicating whether frequency hopping is enabled, a quantity of frequency hops, or an offset associated with frequency hopping, or one or more partial frequency sounding parameters.

In a second aspect, alone or in combination with the first aspect, the set of one or more frequency domain parameters includes one or more RRC configuration parameters.

In a third aspect, alone or in combination with one or more of the first and second aspects, the set of one or more frequency domain parameters includes at least one of a transmission combination parameter associated with a frequency domain density, a transmission combination offset parameter, a frequency domain shift parameter, a frequency domain position parameter, a first frequency domain hopping parameter associated with an SRS bandwidth configuration row index value, a second frequency domain hopping parameter associated with an SRS bandwidth configuration column index value, a third frequency domain hopping parameter associated with at least one of indicating whether frequency hopping is enabled, a quantity of frequency hops, or an offset associated with frequency hopping, or one or more partial frequency sounding parameters.

In a fourth aspect, alone or in combination with one or more of the first through third aspects, the set of one or more frequency domain parameters includes a transmission combination parameter associated with a frequency domain density, and a transmission combination offset parameter.

In a fifth aspect, alone or in combination with one or more of the first through fourth aspects, the set of one or more frequency domain parameters includes a frequency domain shift parameter, a frequency domain position parameter, a first frequency domain hopping parameter associated with an SRS bandwidth index value, a second frequency domain hopping parameter associated with an SRS bandwidth column index value, and a third frequency domain hopping parameter associated with at least one of indicating whether frequency hopping is enabled, a quantity of frequency hops, or an offset associated with frequency hopping.

In a sixth aspect, alone or in combination with one or more of the first through fifth aspects, the message is included in a MAC-CE message.

In a seventh aspect, alone or in combination with one or more of the first through sixth aspects, the MAC-CE message indicates the modified information for the one or more frequency domain parameters.

In an eighth aspect, alone or in combination with one or more of the first through seventh aspects, the modified information is associated with all SRS resources associated with the SRS resource set.

In a ninth aspect, alone or in combination with one or more of the first through eighth aspects, the modified information is associated with one or more not activated SRS resource sets.

In a tenth aspect, alone or in combination with one or more of the first through ninth aspects, process 1000 includes transmitting, to the second network node and during a slot, an ACK message indicating that a communication associated with the MAC-CE message was successfully decoded by the first network node, and applying the modified information for the one or more frequency domain parameters for the at least one SRS resource a quantity of slots after the slot.

In an eleventh aspect, alone or in combination with one or more of the first through tenth aspects, process 1000 includes receiving one or more sets of information for the one or more frequency domain parameters associated with the SRS resource set, and the MAC-CE message activates a set of information, from the one or more sets of information, and the set of information includes the modified information with respect to a currently activated or semi-statically configured set of information for the at least one SRS resource.

In a twelfth aspect, alone or in combination with one or more of the first through eleventh aspects, at least one of the one or more sets of information is defined by a wireless communication standard as a default configuration option applicable before any activating MAC-CE message.

In a thirteenth aspect, alone or in combination with one or more of the first through twelfth aspects, the message is included in a DCI message that is not associated with data transmission scheduling.

In a fourteenth aspect, alone or in combination with one or more of the first through thirteenth aspects, the DCI message is associated with a DCI format 1_1 or 1_2.

In a fifteenth aspect, alone or in combination with one or more of the first through fourteenth aspects, the DCI message indicates the modified information for the one or more frequency domain parameters.

In a sixteenth aspect, alone or in combination with one or more of the first through fifteenth aspects, the modified information is associated with all SRS resources associated with the SRS resource set.

In a seventeenth aspect, alone or in combination with one or more of the first through sixteenth aspects, process 1000 includes transmitting, to the second network node and during a slot, an ACK message indicating that the DCI message was successfully decoded by the first network node, and applying the modified information for the one or more frequency domain parameters for the at least one SRS resource a quantity of slots after the slot.

In an eighteenth aspect, alone or in combination with one or more of the first through seventeenth aspects, the DCI message is associated with a DCI format that is associated with modifying SRS configuration parameters.

In a nineteenth aspect, alone or in combination with one or more of the first through eighteenth aspects, the SRS resource set is an aperiodic SRS resource set, and the message is included in a DCI message that schedules a transmission of the aperiodic SRS resource set.

In a twentieth aspect, alone or in combination with one or more of the first through nineteenth aspects, the DCI message does not schedule any data communications.

In a twenty-first aspect, alone or in combination with one or more of the first through twentieth aspects, the DCI message schedules the aperiodic SRS resource set via an SRS trigger state indicated by an SRS request field, and the DCI message indicates the modified information for the one or more frequency domain parameters via one or more other fields of the DCI message.

In a twenty-second aspect, alone or in combination with one or more of the first through twenty-first aspects, the SRS trigger state schedules multiple aperiodic SRS resource sets including the aperiodic SRS resource set, and the DCI message indicates respective modified information for the one or more frequency domain parameters for each of the multiple aperiodic SRS resource sets.

In a twenty-third aspect, alone or in combination with one or more of the first through twenty-second aspects, the SRS trigger state schedules multiple aperiodic SRS resource sets including the aperiodic SRS resource set, and the modified information for the one or more frequency domain parameters is associated with each of the multiple aperiodic SRS resource sets.

In a twenty-fourth aspect, alone or in combination with one or more of the first through twenty-third aspects, the DCI message includes the modified information.

In a twenty-fifth aspect, alone or in combination with one or more of the first through twenty-fourth aspects, the DCI message indicates one or more indices associated with a data structure that includes multiple SRS configuration options and the one or more indices correspond to the modified information.

In a twenty-sixth aspect, alone or in combination with one or more of the first through twenty-fifth aspects, the DCI message schedules one or more data communications.

In a twenty-seventh aspect, alone or in combination with one or more of the first through twenty-sixth aspects, process 1000 includes receiving, from the second network node, an RRC configuration of multiple SRS trigger states associated with the SRS resource set, wherein the multiple SRS trigger states are associated with different respective configurations for the set of one or more frequency domain parameters for the at least one SRS resource, and the DCI message indicates a triggered SRS trigger state, from the multiple SRS trigger states, that is associated with the modified information for the one or more frequency domain parameters.

In a twenty-eighth aspect, alone or in combination with one or more of the first through twenty-seventh aspects, process 1000 includes receiving, from the second network node, a MAC-CE message activating one or more SRS trigger states including the SRS trigger state, wherein the MAC-CE message indicates an association of the one or more SRS trigger states to code points of an SRS request field of the DCI message.

In a twenty-ninth aspect, alone or in combination with one or more of the first through twenty-eighth aspects, the SRS resource set is a periodic SRS resource set, a semi-persistent SRS resource set, or an aperiodic SRS resource set.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a first network node, in accordance with the present disclosure. Example process 1100 is an example where the first network node (e.g., the base station 110, the network entity 605, a CU, a DU, and/or an RU) performs operations associated with dynamic adaptation of SRS frequency domain parameters.

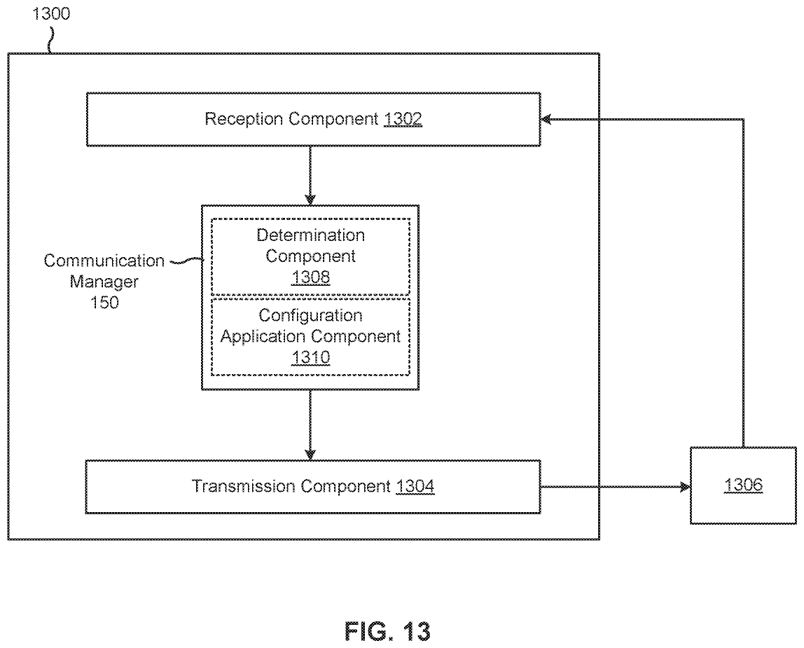

As shown in FIG. 11, in some aspects, process 1100 may include transmitting, to a second network node, an SRS configuration associated with an SRS resource set including one or more SRS resources, the SRS configuration indicating information for a set of one or more frequency domain parameters associated with the SRS resource set (block 1110). For example, the first network node (e.g., using communication manager 150 and/or transmission component 1304, depicted in FIG. 13) may transmit, to a second network node, an SRS configuration associated with an SRS resource set including one or more SRS resources, the SRS configuration indicating information for a set of one or more frequency domain parameters associated with the SRS resource set, as described above.

As further shown in FIG. 11, in some aspects, process 1100 may include transmitting, to the second network node, a message indicating modified information for a dynamic reconfiguration of one or more frequency domain parameters, from the set of one or more frequency domain parameters, associated with at least one SRS resources of the one or more SRS resources (block 1120). For example, the first network node (e.g., using communication manager 150 and/or transmission component 1304, depicted in FIG. 13) may transmit, to the second network node, a message indicating modified information for a dynamic reconfiguration of one or more frequency domain parameters, from the set of one or more frequency domain parameters, associated with at least one SRS resources of the one or more SRS resources, as described above.

As further shown in FIG. 11, in some aspects, process 1100 may include receiving, from the second network node, an SRS, using the at least one SRS resource, in accordance with the modified information for the one or more frequency domain parameters (block 1130). For example, the first network node (e.g., using communication manager 150 and/or reception component 1302, depicted in FIG. 13) may receive, from the second network node, an SRS, using the at least one SRS resource, in accordance with the modified information for the one or more frequency domain parameters, as described above.

Process 1100 may include additional aspects, such as any single aspect or any combination of aspects described below and/or in connection with one or more other processes described elsewhere herein.

In a first aspect, the set of one or more frequency domain parameters includes at least one of a transmission combination parameter associated with a frequency domain density, a transmission combination offset parameter, a frequency domain shift parameter, a frequency domain position parameter, a first frequency domain hopping parameter associated with an SRS bandwidth configuration row index value, a second frequency domain hopping parameter associated with an SRS bandwidth configuration column index value, a third frequency domain hopping parameter associated with at least one of indicating whether frequency hopping is enabled, a quantity of frequency hops, or an offset associated with frequency hopping, or one or more partial frequency sounding parameters.

In a second aspect, alone or in combination with the first aspect, the set of one or more frequency domain parameters includes one or more radio resource control (RRC) configuration parameters.

In a third aspect, alone or in combination with one or more of the first and second aspects, the one or more frequency domain parameters include at least one of a transmission combination parameter associated with a frequency domain density, a transmission combination offset parameter, a frequency domain shift parameter, a frequency domain position parameter, a first frequency domain hopping parameter associated with an SRS bandwidth configuration row index value, a second frequency domain hopping parameter associated with an SRS bandwidth configuration column index value, a third frequency domain hopping parameter associated with at least one of indicating whether frequency hopping is enabled, a quantity of frequency hops, or an offset associated with frequency hopping, or one or more partial frequency sounding parameters.

In a fourth aspect, alone or in combination with one or more of the first through third aspects, the one or more frequency domain parameters include a transmission combination parameter associated with a frequency domain density, and a transmission combination offset parameter.

In a fifth aspect, alone or in combination with one or more of the first through fourth aspects, the one or more frequency domain parameters include a frequency domain shift parameter, a frequency domain position parameter, a first frequency domain hopping parameter associated with an SRS bandwidth index value, a second frequency domain hopping parameter associated with an SRS bandwidth column index value, and a third frequency domain hopping parameter associated with at least one of indicating whether frequency hopping is enabled, a quantity of frequency hops, or an offset associated with frequency hopping.

In a sixth aspect, alone or in combination with one or more of the first through fifth aspects, the message is included in a MAC-CE message.

In a seventh aspect, alone or in combination with one or more of the first through sixth aspects, the MAC-CE message indicates the modified information for the one or more frequency domain parameters.

In an eighth aspect, alone or in combination with one or more of the first through seventh aspects, the modified information is associated with all SRS resources associated with the SRS resource set.

In a ninth aspect, alone or in combination with one or more of the first through eighth aspects, the modified information is associated with one or more not activated SRS resource sets.

In a tenth aspect, alone or in combination with one or more of the first through ninth aspects, process 1100 includes receiving, from the second network node and during a slot, an ACK message indicating that a communication associated with the MAC-CE message was successfully decoded by the first network node, and applying the modified information for the one or more frequency domain parameters for the at least one SRS resource a quantity of slots after the slot.

In an eleventh aspect, alone or in combination with one or more of the first through tenth aspects, process 1100 includes transmitting, to the second network node, one or more sets of information for the one or more frequency domain parameters associated with the SRS resource set or the SRS resource, and the MAC-CE message activates a set of information, from the one or more sets of information, wherein the set of information includes the modified information with respect to a currently activated or semi-statically configured set of information for the at least one SRS resource.

In a twelfth aspect, alone or in combination with one or more of the first through eleventh aspects, at least one of the one or more sets of information is defined by a wireless communication standard as a default configuration option applicable before any activating MAC-CE message.

In a thirteenth aspect, alone or in combination with one or more of the first through twelfth aspects, the message is included in a DCI message that is not associated with scheduling communications.

In a fourteenth aspect, alone or in combination with one or more of the first through thirteenth aspects, the DCI message is associated with a DCI format 1_1 or 1_2.

In a fifteenth aspect, alone or in combination with one or more of the first through fourteenth aspects, the DCI message indicates the modified information for the one or more frequency domain parameters.

In a sixteenth aspect, alone or in combination with one or more of the first through fifteenth aspects, the modified information is associated with all SRS resources associated with the SRS resource set.

In a seventeenth aspect, alone or in combination with one or more of the first through sixteenth aspects, process 1100 includes receiving, from the second network node and during a slot, an ACK message indicating that the DCI message was successfully decoded by the first network node, and applying the modified information for the one or more frequency domain parameters for the at least one SRS resource a quantity of slots after the slot.

In an eighteenth aspect, alone or in combination with one or more of the first through seventeenth aspects, the DCI message is associated with a DCI format that is associated with modifying SRS configuration parameters.

In a nineteenth aspect, alone or in combination with one or more of the first through eighteenth aspects, the SRS resource set is an aperiodic SRS resource set, and the message is included in a DCI message that schedules a transmission of the aperiodic SRS resource set.

In a twentieth aspect, alone or in combination with one or more of the first through nineteenth aspects, the DCI message does not schedule any data communications.

In a twenty-first aspect, alone or in combination with one or more of the first through twentieth aspects, the DCI message schedules the aperiodic SRS resource set via an SRS trigger state indicated by an SRS request field, and the DCI message indicates the modified information for the one or more frequency domain parameters via one or more other fields of the DCI message.

In a twenty-second aspect, alone or in combination with one or more of the first through twenty-first aspects, the SRS trigger state schedules multiple aperiodic SRS resource sets including the aperiodic SRS resource set, and the DCI message indicates respective modified information for the one or more frequency domain parameters for each of the multiple aperiodic SRS resource sets.

In a twenty-third aspect, alone or in combination with one or more of the first through twenty-second aspects, the SRS trigger state schedules multiple aperiodic SRS resource sets including the aperiodic SRS resource set, and the modified information for the one or more frequency domain parameters is associated with each of the multiple aperiodic SRS resource sets.

In a twenty-fourth aspect, alone or in combination with one or more of the first through twenty-third aspects, the DCI message includes the modified information.

In a twenty-fifth aspect, alone or in combination with one or more of the first through twenty-fourth aspects, the DCI message indicates one or more indices associated with a data structure that includes multiple SRS configuration options and the one or more indices correspond to one of the modified information.

In a twenty-sixth aspect, alone or in combination with one or more of the first through twenty-fifth aspects, the DCI message schedules one or more data communications.

In a twenty-seventh aspect, alone or in combination with one or more of the first through twenty-sixth aspects, process 1100 includes transmitting, to the second network node, an RRC configuration of multiple SRS trigger states associated with the SRS resource set, wherein the multiple SRS trigger states are associated with different respective configurations for the set of one or more frequency domain parameters for the at least one SRS resource set, and the DCI message indicates a triggered SRS trigger state, from the multiple SRS trigger states, that is associated with the modified information for the one or more frequency domain parameters.

In a twenty-eighth aspect, alone or in combination with one or more of the first through twenty-seventh aspects, process 1100 includes transmitting, to the second network node, a MAC-CE message activating one or more SRS trigger states including the SRS trigger state, wherein the MAC-CE message indicates an association of the one or more SRS trigger states to code points of an SRS request field of the DCI message.

In a twenty-ninth aspect, alone or in combination with one or more of the first through twenty-eighth aspects, the SRS resource set is a periodic SRS resource set, a semi-persistent SRS resource set, or an aperiodic SRS resource set.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a configuration application component 1208, among other examples.

In some aspects, the apparatus 1200 may be configured to perform one or more operations described herein in connection with FIGS. 6-9. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive, from another network node, an SRS configuration associated with an SRS resource set including one or more SRS resources, the SRS configuration indicating information for a set of one or more frequency domain parameters associated with the SRS resource set. The reception component 1202 may receive, from the other network node, a message indicating modified information for a dynamic reconfiguration of one or more frequency domain parameters, from the set of one or more frequency domain parameters, associated with at least one SRS resources of the one or more SRS resources. The transmission component 1204 may transmit, to the other network node, an SRS, using the at least one SRS resource, in accordance with the modified information for the one or more frequency domain parameters.

The transmission component 1204 may transmit to the second network node, and during a slot, an ACK message indicating that a communication associated with the MAC-CE message was successfully decoded by the first network node. The configuration application component 1208 may apply the modified information for the one or more frequency domain parameters for the SRS resource set a quantity of slots after the slot.

The reception component 1202 may receive one or more sets of information for the one or more frequency domain parameters associated with the SRS resource set.

The transmission component 1204 may transmit, to the second network node and during a slot, an ACK message indicating that the DCI message was successfully decoded by the first network node. The configuration application component 1208 may apply the modified information for the one or more frequency domain parameters for the at least one SRS resource a quantity of slots after the slot.

The reception component 1202 may receive, from the second network node, an RRC configuration of multiple SRS trigger states associated with the SRS resource set, wherein the multiple SRS trigger states are associated with different respective configurations for the set of one or more frequency domain parameters for the SRS resource set.

The reception component 1202 may receive, from the second network node, a MAC-CE message activating one or more SRS trigger states including the SRS trigger state, wherein the MAC-CE message indicates an association of the one or more SRS trigger states to code points of an SRS request field of the DCI message.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network entity, or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include one or more of a determination component 1308, and/or a configuration application component 1310, among other examples.

In some aspects, the apparatus 1300 may be configured to perform one or more operations described herein in connection with FIGS. 6-9. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the base station described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the base station described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the base station described in connection with FIG. 2. In some aspects, the transmission component 1304 may be co-located with the reception component 1302 in a transceiver.

The transmission component 1304 may transmit, to a another network node, an SRS configuration associated with an SRS resource set including one or more SRS resources, the SRS configuration indicating information for a set of one or more frequency domain parameters associated with the SRS resource set. The transmission component 1304 may transmit, to the other network node, a message indicating modified information for a dynamic reconfiguration of one or more frequency domain parameters, from the set of one or more frequency domain parameters, associated with at least one SRS resources of the one or more SRS resources. The reception component 1302 may receive, from the other network node, an SRS, using the at least one SRS resource, in accordance with the modified information for the one or more frequency domain parameters.

The determination component 1308 may determine the SRS configuration associated with an SRS resource set. The determination component 1308 may determine the modified information for one or more frequency domain parameters.

The reception component 1302 may receive, from the second network node and during a slot, an ACK message indicating that a communication associated with the MAC-CE message was successfully decoded by the first network node. The configuration application component 1310 may apply the modified information for the one or more frequency domain parameters for the at least one SRS resource a quantity of slots after the slot.

The transmission component 1304 may transmit, to the second network node, one or more sets of information for the one or more frequency domain parameters associated with the SRS resource set or the SRS resource.

The reception component 1302 may receive, from the second network node and during a slot, an ACK message indicating that the DCI message was successfully decoded by the first network node. The configuration application component 1310 may apply the modified information for the one or more frequency domain parameters for the at least one SRS resource a quantity of slots after the slot.

The transmission component 1304 may transmit, to the second network node, an RRC configuration of multiple SRS trigger states associated with the SRS resource set, wherein the multiple SRS trigger states are associated with different respective configurations for the set of one or more frequency domain parameters for the at least one SRS resource.

The transmission component 1304 may transmit, to the second network node, a MAC-CE message activating one or more SRS trigger states including the SRS trigger state, wherein the MAC-CE message indicates an association of the one or more SRS trigger states to code points of an SRS request field of the DCI message.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a first network node, comprising: receiving, from a second network node, a sounding reference signal (SRS) configuration associated with an SRS resource set including one or more SRS resources, the SRS configuration indicating information for a set of one or more frequency domain parameters associated with the SRS resource set; receiving, from the second network node, a message indicating modified information for a dynamic reconfiguration of one or more frequency domain parameters, from the set of one or more frequency domain parameters, associated with at least one SRS resources of the one or more SRS resources; and transmitting, to the second network node, an SRS, using the at least one SRS resource, in accordance with the modified information for the one or more frequency domain parameters.

Aspect 2: The method of Aspect 1, wherein the set of one or more frequency domain parameters includes at least one of: a transmission combination parameter associated with a frequency domain density, a transmission combination offset parameter, a frequency domain shift parameter, a frequency domain position parameter, a first frequency domain hopping parameter associated with an SRS bandwidth configuration row index value, a second frequency domain hopping parameter associated with an SRS bandwidth configuration column index value, a third frequency domain hopping parameter associated with at least one of indicating whether frequency hopping is enabled, a quantity of frequency hops, or an offset associated with frequency hopping, or one or more partial frequency sounding parameters.

Aspect 3: The method of any of Aspects 1-2, wherein the set of one or more frequency domain parameters includes one or more radio resource control (RRC) configuration parameters.

Aspect 4: The method of any of Aspects 1-3, wherein the one or more frequency domain parameters includes at least one of: a transmission combination parameter associated with a frequency domain density, a transmission combination offset parameter, a frequency domain shift parameter, a frequency domain position parameter, a first frequency domain hopping parameter associated with an SRS bandwidth configuration row index value, a second frequency domain hopping parameter associated with an SRS bandwidth configuration column index value, a third frequency domain hopping parameter associated with at least one of indicating whether frequency hopping is enabled, a quantity of frequency hops, or an offset associated with frequency hopping, or one or more partial frequency sounding parameters.

Aspect 5: The method of any of Aspects 1-4, wherein the one or more frequency domain parameters includes: a transmission combination parameter associated with a frequency domain density, and a transmission combination offset parameter.

Aspect 6: The method of any of Aspects 1-5, wherein the one or more frequency domain parameters includes: a frequency domain shift parameter, a frequency domain position parameter, a first frequency domain hopping parameter associated with an SRS bandwidth index value, a second frequency domain hopping parameter associated with an SRS bandwidth column index value, and a third frequency domain hopping parameter associated with at least one of indicating whether frequency hopping is enabled, a quantity of frequency hops, or an offset associated with frequency hopping.

Aspect 7: The method of any of Aspects 1-6, wherein the message is included in a medium access control (MAC) control element (MAC-CE) message.

Aspect 8: The method of Aspect 7, wherein the MAC-CE message indicates the modified information for the one or more frequency domain parameters.

Aspect 9: The method of Aspect 8, wherein the modified information is associated with all SRS resources associated with the SRS resource set.

Aspect 10: The method of any of Aspects 8-9, wherein the modified information is associated with one or more not activated SRS resource sets.

Aspect 11: The method of any of Aspects 7-10, further comprising: transmitting, to the second network node and during a slot, an acknowledgment (ACK) message indicating that a communication associated with the MAC-CE message was successfully decoded by the first network node; and applying the modified information for the one or more frequency domain parameters for the at least one SRS resource a quantity of slots after the slot.

Aspect 12: The method of any of Aspects 7-11. further comprising: receiving one or more sets of information for the one or more frequency domain parameters associated with the SRS resource set, and wherein the MAC-CE message activates a set of information, from the one or more sets of information, wherein the set of information includes the modified information with respect to a currently activated or semi-statically configured set of information for the at least one SRS resource.

Aspect 13: The method of Aspect 12, wherein at least one of the one or more sets of information is defined by a wireless communication standard as a default configuration option applicable before any activating MAC-CE message.

Aspect 14: The method of any of Aspects 1-6, wherein the message is included in a downlink control information (DCI) message that is not associated with data transmission scheduling.

Aspect 15: The method of Aspect 14, wherein the DCI message is associated with a DCI format 1_1 or 1_2.

Aspect 16: The method of any of Aspects 14-15, wherein the DCI message indicates the modified information for the one or more frequency domain parameters.

Aspect 17: The method of Aspect 16, wherein the modified information is associated with all SRS resources associated with the SRS resource set.

Aspect 18: The method of any of Aspects 14-17, further comprising: transmitting, to the second network node and during a slot, an acknowledgment (ACK) message indicating that the DCI message was successfully decoded by the first network node; and applying the modified information for the one or more frequency domain parameters for the at least one SRS resource a quantity of slots after the slot.

Aspect 19: The method of any of Aspects 14-18, wherein the DCI message is associated with a DCI format that is associated with modifying SRS configuration parameters.

Aspect 20: The method of any of Aspects 1-6, wherein the SRS resource set is an aperiodic SRS resource set, and wherein the message is included in a downlink control information (DCI) message that schedules a transmission of the aperiodic SRS resource set.

Aspect 21: The method of Aspect 20, wherein the DCI message does not schedule any data communications.

Aspect 22: The method of Aspect 21, wherein the DCI message schedules the aperiodic SRS resource set via an SRS trigger state indicated by an SRS request field, and wherein the DCI message indicates the modified information for the one or more frequency domain parameters via one or more other fields of the DCI message.

Aspect 23: The method of Aspect 22, wherein the SRS trigger state schedules multiple aperiodic SRS resource sets including the aperiodic SRS resource set, and wherein the DCI message indicates respective modified information for the one or more frequency domain parameters for each of the multiple aperiodic SRS resource sets.

Aspect 24: The method of any of Aspects 22, wherein the SRS trigger state schedules multiple aperiodic SRS resource sets including the aperiodic SRS resource set, and wherein the modified information for the one or more frequency domain parameters is associated with each of the multiple aperiodic SRS resource sets.

Aspect 25: The method of any of Aspects 21-24, wherein the DCI message includes the modified information.

Aspect 26: The method of any of Aspects 21-25, wherein the DCI message indicates one or more indices associated with a data structure that includes multiple SRS configuration options and the one or more indices correspond to the modified information.

Aspect 27: The method of Aspect 20, wherein the DCI message schedules one or more data communications.

Aspect 28: The method of Aspect 27, further comprising: receiving, from the second network node, a radio resource control (RRC) configuration of multiple SRS trigger states associated with the SRS resource set, wherein the multiple SRS trigger states are associated with different respective configurations for the set of one or more frequency domain parameters for the at least one SRS resource, and wherein the DCI message indicates a triggered SRS trigger state, from the multiple SRS trigger states, that is associated with the modified information for the one or more frequency domain parameters, wherein the DCI message indicates a triggered SRS trigger state, from the multiple SRS trigger states, that is associated with the modified information for the one or more frequency domain parameters.

Aspect 29: The method of Aspect 28, further comprising: receiving, from the second network node, a medium access control (MAC) control element (MAC-CE) message activating one or more SRS trigger states including the SRS trigger state, wherein the MAC-CE message indicates an association of the one or more SRS trigger states to code points of an SRS request field of the DCI message.

Aspect 30: The method of any of Aspects 1-29, wherein the SRS resource set is a periodic SRS resource set, a semi-persistent SRS resource set, or an aperiodic SRS resource set.

Aspect 31: A method of wireless communication performed by a first network node, comprising: transmitting, to a second network node, a sounding reference signal (SRS) configuration associated with an SRS resource set including one or more SRS resources, the SRS configuration indicating information for a set of one or more frequency domain parameters associated with the SRS resource set; transmitting, to the second network node, a message indicating modified information for a dynamic reconfiguration of one or more frequency domain parameters, from the set of one or more frequency domain parameters, associated with at least one SRS resources of the one or more SRS resources; and receiving, from the second network node, an SRS, using the at least one SRS resource, in accordance with the modified information for the one or more frequency domain parameters.

Aspect 32: The method of Aspect 31, wherein the set of one or more frequency domain parameters includes at least one of: a transmission combination parameter associated with a frequency domain density, a transmission combination offset parameter, a frequency domain shift parameter, a frequency domain position parameter, a first frequency domain hopping parameter associated with an SRS bandwidth configuration row index value, a second frequency domain hopping parameter associated with an SRS bandwidth configuration column index value, a third frequency domain hopping parameter associated with at least one of indicating whether frequency hopping is enabled, a quantity of frequency hops, or an offset associated with frequency hopping, or one or more partial frequency sounding parameters.

Aspect 33: The method of any of Aspects 31-32, wherein the set of one or more frequency domain parameters includes one or more radio resource control (RRC) configuration parameters.

Aspect 34: The method of any of Aspects 31-33, wherein the one or more frequency domain parameters include at least one of: a transmission combination parameter associated with a frequency domain density, a transmission combination offset parameter, a frequency domain shift parameter, a frequency domain position parameter, a first frequency domain bopping parameter associated with an SRS bandwidth configuration row index value, a second frequency domain hopping parameter associated with an SRS bandwidth configuration column index value, a third frequency domain hopping parameter associated with at least one of indicating whether frequency hopping is enabled, a quantity of frequency hops, or an offset associated with frequency hopping, or one or more partial frequency sounding parameters.

Aspect 35: The method of any of Aspects 31-34, wherein the one or more frequency domain parameters include: a transmission combination parameter associated with a frequency domain density, and a transmission combination offset parameter.

Aspect 36: The method of any of Aspects 31-35, wherein the one or more frequency domain parameters include: a frequency domain shift parameter, a frequency domain position parameter, a first frequency domain hopping parameter associated with an SRS bandwidth index value, a second frequency domain hopping parameter associated with an SRS bandwidth column index value, and a third frequency domain hopping parameter associated with at least one of indicating whether frequency hopping is enabled, a quantity of frequency hops, or an offset associated with frequency hopping.

Aspect 37: The method of any of Aspects 31-36, wherein the message is included in a medium access control (MAC) control element (MAC-CE) message.

Aspect 38: The method of Aspect 37, wherein the MAC-CE message indicates the modified information for the one or more frequency domain parameters.

Aspect 39: The method of Aspect 38, wherein the modified information is associated with all SRS resources associated with the SRS resource set.

Aspect 40: The method of any of Aspects 38-39, wherein the modified information is associated with one or more not activated SRS resource sets.

Aspect 41: The method of any of Aspects 37-40, further comprising: receiving, from the second network node and during a slot, an acknowledgment (ACK) message indicating that a communication associated with the MAC-CE message was successfully decoded by the first network node; and applying the modified information for the one or more frequency domain parameters for the at least one SRS resource a quantity of slots after the slot.

Aspect 42: The method of any of Aspects 37-41, further comprising: transmitting, to the second network node, one or more sets of information for the one or more frequency domain parameters associated with the SRS resource set or the SRS resource, and wherein the MAC-CE message activates a set of information, from the one or more sets of information, wherein the set of information includes the modified information with respect to a currently activated or semi-statically configured set of information for the at least one SRS resource.

Aspect 43: The method of Aspect 42, wherein at least one of the one or more sets of information are defined by a wireless communication standard as a default configuration option applicable before any activating MAC-CE message.

Aspect 44: The method of any of Aspects 31-36, wherein the message is included in a downlink control information (DCI) message that is not associated with scheduling communications.

Aspect 45: The method of Aspect 44, wherein the DCI message is associated with a DCI format 1_1 or 1_2.

Aspect 46: The method of any of Aspects 44-45, wherein the DCI message indicates the modified information for the one or more frequency domain parameters.

Aspect 47: The method of Aspect 46, wherein the modified information is associated with all SRS resources associated with the SRS resource set.

Aspect 48: The method of any of Aspects 44-47, further comprising: receiving, from the second network node and during a slot, an acknowledgment (ACK) message indicating that the DCI message was successfully decoded by the first network node; and applying the modified information for the one or more frequency domain parameters for the at least one SRS resource a quantity of slots after the slot.

Aspect 49: The method of any of Aspects 44-48, wherein the DCI message is associated with a DCI format that is associated with modifying SRS configuration parameters.

Aspect 50: The method of any of Aspects 31-36, wherein the SRS resource set is an aperiodic SRS resource set, and wherein the message is included in a downlink control information (DCI) message that schedules a transmission of the aperiodic SRS resource set.

Aspect 51: The method of Aspect 50, wherein the DCI message does not schedule any data communications.

Aspect 52: The method of Aspect 51, wherein the DCI message schedules the aperiodic SRS resource set via an SRS trigger state indicated by an SRS request field, and wherein the DCI message indicates the modified information for the one or more frequency domain parameters via one or more other fields of the DCI message.

Aspect 53: The method of Aspect 52, wherein the SRS trigger state schedules multiple aperiodic SRS resource sets including the aperiodic SRS resource set, and wherein the DCI message indicates respective modified information for the one or more frequency domain parameters for each of the multiple aperiodic SRS resource sets.

Aspect 54: The method of Aspect 52, wherein the SRS trigger state schedules multiple aperiodic SRS resource sets including the aperiodic SRS resource set, and wherein the modified information for the one or more frequency domain parameters is associated with each of the multiple aperiodic SRS resource sets.

Aspect 55: The method of any of Aspects 51-54, wherein the DCI message includes the modified information.

Aspect 56: The method of any of Aspects 51-55, wherein the DCI message indicates one or more indices associated with a data structure that includes multiple SRS configuration options and the one or more indices correspond to one of the modified information.

Aspect 57: The method of any of Aspects 50-56, wherein the DCI message schedules one or more data communications.

Aspect 58: The method of Aspect 57, further comprising: transmitting, to the second network node, a radio resource control (RRC) configuration of multiple SRS trigger states associated with the SRS resource set, wherein the multiple SRS trigger states are associated with different respective configurations for the set of one or more frequency domain parameters for the at least one SRS resource, and wherein the DCI message indicates a triggered SRS trigger state, from the multiple SRS trigger states, that is associated with the modified information for the one or more frequency domain parameters, wherein the DCI message indicates a triggered SRS trigger state, from the multiple SRS trigger states, that is associated with the modified information for the one or more frequency domain parameters.

Aspect 59: The method of Aspect 58, further comprising: transmitting, to the second network node, a medium access control (MAC) control element (MAC-CE) message activating one or more SRS trigger states including the SRS trigger state, wherein the MAC-CE message indicates an association of the one or more SRS trigger states to code points of an SRS request field of the DCI message.

Aspect 60: The method of any of Aspects 31-59, wherein the SRS resource set is a periodic SRS resource set, a semi-persistent SRS resource set, or an aperiodic SRS resource set.

Aspect 61: An apparatus for wireless communication at a device, comprising a processor; memory coupled with the processor; and instructions stored in the memory and executable by the processor to cause the apparatus to perform the method of one or more of Aspects 1-30.

Aspect 62: A device for wireless communication, comprising a memory and one or more processors coupled to the memory, the one or more processors configured to perform the method of one or more of Aspects 1-30.

Aspect 63: An apparatus for wireless communication, comprising at least one means for performing the method of one or more of Aspects 1-30.

Aspect 64: A non-transitory computer-readable medium storing code for wireless communication, the code comprising instructions executable by a processor to perform the method of one or more of Aspects 1-30.

Aspect 65: A non-transitory computer-readable medium storing a set of instructions for wireless communication, the set of instructions comprising one or more instructions that, when executed by one or more processors of a device, cause the device to perform the method of one or more of Aspects 1-30.

Aspect 66: An apparatus for wireless communication at a device, comprising a processor; memory coupled with the processor; and instructions stored in the memory and executable by the processor to cause the apparatus to perform the method of one or more of Aspects 31-60.

Aspect 67: A device for wireless communication, comprising a memory and one or more processors coupled to the memory, the one or more processors configured to perform the method of one or more of Aspects 31-60.

Aspect 68: An apparatus for wireless communication, comprising at least one means for performing the method of one or more of Aspects 31-60.

Aspect 69: A non-transitory computer-readable medium storing code for wireless communication, the code comprising instructions executable by a processor to perform the method of one or more of Aspects 31-60.

Aspect 70: A non-transitory computer-readable medium storing a set of instructions for wireless communication, the set of instructions comprising one or more instructions that, when executed by one or more processors of a device, cause the device to perform the method of one or more of Aspects 31-60.

The foregoing disclosure provides illustration and description but is neither exhaustive nor limiting of the scope of this disclosure. For example, various aspects and examples are disclosed herein, but this disclosure is not limited to the precise form in which such aspects and examples are described. Additionally, the terms aspects and examples are used interchangeably. Modifications and variations may be made in light of the above disclosure or may be acquired from practice of the aspects.

As used herein, the term “component” shall be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, any combinations thereof, or otherwise. As used herein, a “processor” is implemented in hardware and/or a combination of hardware and software. Systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art understand that software and hardware can be designed to implement techniques described herein based on this disclosure.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations do not limit the scope of this disclosure to such particular combinations or features. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” include one or more items and may be used interchangeably with “one or more.” Further, as used herein, the article “the” includes one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

What is claimed is:

1. A first network node for wireless communication, comprising:
a memory; and
one or more processors communicatively coupled to the memory, wherein the one or more processors are configured to:
receive, from a second network node, a sounding reference signal (SRS) configuration associated with an SRS resource set including one or more SRS resources, the SRS configuration indicating information for a set of one or more frequency domain parameters associated with the SRS resource set;
receive, from the second network node, a message indicating modified information for a dynamic reconfiguration of one or more frequency domain parameters, from the set of one or more frequency domain parameters, associated with at least one SRS resources of the one or more SRS resources; and
transmit, to the second network node, an SRS, using the at least one SRS resource included in the SRS resource set, in accordance with the modified information for the one or more frequency domain parameters.

2. The first network node of claim 1, wherein the message is included in a medium access control (MAC) control element (MAC-CE) message.

3. The first network node of claim 2, wherein the MAC-CE message indicates the modified information for the one or more frequency domain parameters.

4. The first network node of claim 2, wherein the one or more processors are further configured to:
transmit, to the second network node and during a slot, an acknowledgment (ACK) message indicating that a communication associated with the MAC-CE message was successfully decoded by the first network node; and
apply the modified information for the one or more frequency domain parameters for the at least one SRS resource a quantity of slots after the slot.

5. The first network node of claim 2, wherein the one or more processors are further configured to:
receive one or more sets of information for the one or more frequency domain parameters associated with the SRS resource set, and
wherein the MAC-CE message activates a set of information, from the one or more sets of information, wherein the set of information includes the modified information with respect to a currently activated or semi-statically configured set of information for the at least one SRS resource.

6. The first network node of claim 5, wherein at least one of the one or more sets of information is defined by a wireless communication standard as a default configuration option applicable before any activating MAC-CE message.

7. The first network node of claim 1, wherein the message is included in a downlink control information (DCI) message that is not associated with data transmission scheduling.

8. The first network node of claim 7, wherein the DCI message indicates the modified information for the one or more frequency domain parameters.

9. The first network node of claim 7, wherein the one or more processors are further configured to:
transmit, to the second network node and during a slot, an acknowledgment (ACK) message indicating that the DCI message was successfully decoded by the first network node; and
apply the modified information for the one or more frequency domain parameters for the at least one SRS resource a quantity of slots after the slot.

10. The first network node of claim 1, wherein the SRS resource set is an aperiodic SRS resource set, and wherein the message is included in a downlink control information (DCI) message that schedules a transmission of the aperiodic SRS resource set.

11. The first network node of claim 10, wherein the DCI message does not schedule any data communications, wherein the DCI message schedules the aperiodic SRS resource set via an SRS trigger state indicated by an SRS request field, and wherein the DCI message indicates the modified information for the one or more frequency domain parameters via one or more other fields of the DCI message.

12. A first network node for wireless communication, comprising:
a memory; and
one or more processors communicatively coupled to the memory, wherein the one or more processors are configured to:
transmit, to a second network node, a sounding reference signal (SRS) configuration associated with an SRS resource set including one or more SRS resources, the SRS configuration indicating information for a set of one or more frequency domain parameters associated with the SRS resource set;
transmit, to the second network node, a message indicating modified information for a dynamic reconfiguration of one or more frequency domain parameters, from the set of one or more frequency domain parameters, associated with at least one SRS resources of the one or more SRS resources; and
receive, from the second network node, an SRS, using the at least one SRS resource, in accordance with the modified information for the one or more frequency domain parameters.

13. The first network node of claim 12, wherein the set of one or more frequency domain parameters includes at least one of:
a transmission combination parameter associated with a frequency domain density,
a transmission combination offset parameter,
a frequency domain shift parameter,
a frequency domain position parameter,
a first frequency domain hopping parameter associated with an SRS bandwidth configuration row index value,
a second frequency domain hopping parameter associated with an SRS bandwidth configuration column index value,
a third frequency domain hopping parameter associated with at least one of indicating whether frequency hopping is enabled, a quantity of frequency hops, or an offset associated with frequency hopping, or
one or more partial frequency sounding parameters.

14. The first network node of claim 12, wherein the SRS resource set is an aperiodic SRS resource set, and wherein the message is included in a downlink control information (DCI) message that schedules a transmission of the aperiodic SRS resource set, and wherein the DCI message does not schedule any data communications.

15. The first network node of claim 14, wherein the DCI message schedules the aperiodic SRS resource set via an SRS trigger state indicated by an SRS request field, and wherein the DCI message indicates the modified information for the one or more frequency domain parameters via one or more other fields of the DCI message, and wherein the SRS trigger state schedules multiple aperiodic SRS resource sets including the aperiodic SRS resource set, and wherein the DCI message indicates respective modified information for the one or more frequency domain parameters for each of the multiple aperiodic SRS resource sets or the modified information for the one or more frequency domain parameters is associated with each of the multiple aperiodic SRS resource sets.

16. A method of wireless communication performed by a first network node, comprising:
receiving, from a second network node, a sounding reference signal (SRS) configuration associated with an SRS resource set including one or more SRS resources, the SRS configuration indicating information for a set of one or more frequency domain parameters associated with the SRS resource set;
receiving, from the second network node, a message indicating modified information for a dynamic reconfiguration of one or more frequency domain parameters, from the set of one or more frequency domain parameters, associated with at least one SRS resources of the one or more SRS resources; and
transmitting, to the second network node, an SRS, using the at least one SRS resource, in accordance with the modified information for the one or more frequency domain parameters.

17. The method of claim 16, wherein the message is included in a medium access control (MAC) control element (MAC-CE) message.

18. The method of claim 17, wherein the MAC-CE message indicates the modified information for the one or more frequency domain parameters.

19. The method of claim 17, further comprising:
transmitting, to the second network node and during a slot, an acknowledgment (ACK) message indicating that a communication associated with the MAC-CE message was successfully decoded by the first network node; and
applying the modified information for the one or more frequency domain parameters for the at least one SRS resource a quantity of slots after the slot.

20. The method of claim 17, further comprising:
receiving one or more sets of information for the one or more frequency domain parameters associated with the SRS resource set, and
wherein the MAC-CE message activates a set of information, from the one or more sets of information, wherein the set of information includes the modified information with respect to a currently activated or semi-statically configured set of information for the at least one SRS resource.

21. The method of claim 20, wherein at least one of the one or more sets of information is defined by a wireless communication standard as a default configuration option applicable before any activating MAC-CE message.

22. The method of claim 16, wherein the message is included in a downlink control information (DCI) message that is not associated with data transmission scheduling.

23. The method of claim 22, wherein the DCI message indicates the modified information for the one or more frequency domain parameters.

24. The method of claim 22, further comprising:
transmitting, to the second network node and during a slot, an acknowledgment (ACK) message indicating that the DCI message was successfully decoded by the first network node; and
applying the modified information for the one or more frequency domain parameters for the at least one SRS resource a quantity of slots after the slot.

25. The method of claim 16, wherein the SRS resource set is an aperiodic SRS resource set, and wherein the message is included in a downlink control information (DCI) message that schedules a transmission of the aperiodic SRS resource set.

26. The method of claim 25, wherein the DCI message does not schedule any data communications, wherein the DCI message schedules the aperiodic SRS resource set via an SRS trigger state indicated by an SRS request field, and wherein the DCI message indicates the modified information for the one or more frequency domain parameters via one or more other fields of the DCI message.

27. A method of wireless communication performed by a first network node, comprising:
transmitting, to a second network node, a sounding reference signal (SRS) configuration associated with an SRS resource set including one or more SRS resources, the SRS configuration indicating information for a set of one or more frequency domain parameters associated with the SRS resource set;
transmitting, to the second network node, a message indicating modified information for a dynamic reconfiguration of one or more frequency domain parameters, from the set of one or more frequency domain parameters, associated with at least one SRS resources of the one or more SRS resources; and
receiving, from the second network node, an SRS, using the at least one SRS resource, in accordance with the modified information for the one or more frequency domain parameters.

28. The method of claim 27, wherein the set of one or more frequency domain parameters includes at least one of:
a transmission combination parameter associated with a frequency domain density,
a transmission combination offset parameter,
a frequency domain shift parameter,
a frequency domain position parameter,
a first frequency domain hopping parameter associated with an SRS bandwidth configuration row index value,
a second frequency domain hopping parameter associated with an SRS bandwidth configuration column index value,
a third frequency domain hopping parameter associated with at least one of indicating whether frequency hopping is enabled, a quantity of frequency hops, or an offset associated with frequency hopping, or
one or more partial frequency sounding parameters.

29. The method of claim 27, wherein the SRS resource set is an aperiodic SRS resource set, and wherein the message is included in a downlink control information (DCI) message that schedules a transmission of the aperiodic SRS resource set, and wherein the DCI message does not schedule any data communications.

30. The method of claim 29, wherein the DCI message schedules the aperiodic SRS resource set via an SRS trigger state indicated by an SRS request field, and wherein the DCI message indicates the modified information for the one or more frequency domain parameters via one or more other fields of the DCI message, and wherein the SRS trigger state schedules multiple aperiodic SRS resource sets including the aperiodic SRS resource set, and wherein the DCI message indicates respective modified information for the one or more frequency domain parameters for each of the multiple aperiodic SRS resource sets or the modified information for the one or more frequency domain parameters is associated with each of the multiple aperiodic SRS resource sets.
